(19) United States
(12) Patent Application Publication
(10) Pub. No.: US 2010/0130894 A1
(43) Pub. Date: May 27, 2010

(54) MOTION ASSISTING DEVICE

(75) Inventor: Yasushi Ikeuchi, Wako-shi (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 12/617,796

(22) Filed: Nov. 13, 2009

(30) Foreign Application Priority Data
Nov. 26, 2008 (JP) 2008-300807

(51) Int. Cl. A61H 1/00

(52) U.S. Cl. 601/34

(57) ABSTRACT

A motion assisting device comprises a first index value measuring means 65 which measures a first index value indicating a remaining energy amount of an electrical storage device 19 and power regulation means 63 and 64 each of which regulates the motive power of an electric actuator 9 after the time point of measuring the first index value at least according to the first index value measured by the first index value measuring means 65. The power regulation means 63 and 64 regulate the motive power of the electric actuator 9 so that the remaining energy amount of the electrical storage device 19 is maintained at a predetermined lower limit or greater until the end time point of a desired operating time of the motion assisting device A.

### BACKGROUND OF THE INVENTION

1. Field of the Invention

The present invention relates to a motion assisting device which assists a user (a human) in making motions.

2. Description of the Related Art

Conventionally, as this type of motion assisting device, there has been suggested, for example, a motion assisting device disclosed in Japanese Patent Application Laid-Open No. 2007-54616 (hereinafter, referred to as Patent Document 1). This motion assisting device assists a user in making the motions of his/her legs by reducing load on the user's legs (the weight to be supported by the legs) through applying an assisting force (an upward translational force) for supporting a part of the user's body weight during walking of the user or the like.

More specifically, the motion assisting device includes a seating portion on which the user sits in a straddling manner, foot attachment portions respectively attached to the feet of the user's legs, and leg links respectively connecting the foot attachment portions to the seating portion. The leg link has a thigh frame connected to the seating portion through a first joint, a crus frame connected to the thigh frame through a second joint, and a third joint connecting the foot attachment portion to the crus frame, with the leg link bendable at the second joint. Moreover, the motion assisting device is equipped with an electric motor, so that the motive power of the electric motor is transmitted to the second joint of the leg link via a power transmission system. Further, the motive power of the electric motor drives the second joint in the stretching direction of the leg link (the leg link with the foot attachment portion on the floor) to apply an assisting force (an upward translational force) to the user's trunk through the seating portion from the leg link. In this instance, the motive power of the electric motor is feedback-controlled so that a supporting force applied to the leg link from the floor side reaches a required desired value. Moreover, the desired value of the supporting force is set to a predetermined value determined so that the assisting force applied to the user from the seating portion reaches a predetermined value or set to a value obtained by adding a restoring force of the posture of the leg link to the predetermined value.

In the case, however, where the motion assisting device as disclosed in Patent Document 1 is adapted to be supplied with electric power for the electric motor and the like through a power cord from an external power source such as a commercial power supply, the moving range of the user wearing the motion assisting device is limited to a narrow range. Moreover, the power cord frequently tends to hinder the user's motions. Therefore, in this type of motion assisting device, it is preferable to mount an electrical storage device such as a battery on the motion assisting device to supply the electric power to the electric motor and the like from the electrical storage device.

Meanwhile, the motion assisting device as disclosed in Patent Document 1 is usable as an assisting tool for reducing workload of, for example, an operator who works in a factory or other job sites, as well as usable as an assisting tool for assisting a person who lost his/her walking ability or the like in walking or for training purposes. In these various usages, the continuous utilization time of the motion assisting device is not always short. For example, the motion assisting device is often required to be continuously operated for a relatively long predetermined time (for example, a predetermined period of time from a work start time to a work end time or a break time).

In such a case, the motion assisting device equipped with the electrical storage device as described above is not able to operate the electric motor and the like if energy retaining in the electrical storage device runs out along with the progress of energy consumption of the electrical storage device. Therefore, in order to operate the motion assisting device continuously for a predetermined time, it is necessary to maintain the remaining energy in the electrical storage device at a minimum necessary quantity for enabling the electric motor and the like to operate.

In the conventional motion assisting device as described in Patent Document 1, however, the electric motor has been operated without consideration for the remaining energy in the electrical storage device. Therefore, the remaining energy decreasing mode of the electrical storage device tends to vary depending on a user's work or on a target motion pattern. Further, even if the user's work or the target motion pattern is identical, variation occurs in the remaining energy decreasing mode of the electrical storage device, depending on differences in the way of moving of an individual user.

Therefore, the remaining energy in the electrical storage device runs out during the operation of the motion assisting device, which easily leads to a situation where the motion assisting device is not able to continuously operate for a required predetermined time disadvantageously. To solve this problem, the motion assisting device may be equipped with a large-capacity electrical storage device. The configuration, however, leads to upsizing or to increase in the weight of the electrical storage device (consequently, of the motion assisting device) disadvantageously.

### SUMMARY OF THE INVENTION

In view of the above problems, the present invention has been provided. Therefore, it is an object of the present invention to provide a motion assisting device, having an electric actuator which supplies electric power from an electrical storage device, capable of properly preventing remaining energy of the electrical storage device from running out during operation of the motion assisting device without using a large-capacity electrical storage device.

To this end, the present invention provides a motion assisting device having an assisting force transmitting portion which is brought into contact with a predetermined region of a user in such a way that an assisting force for assisting the user in making motions is transmittable to the user, an electric actuator, and an electrical storage device as a power supply of the electric actuator to cause the assisting force transmitting portion to generate the assisting force by motive power of the electric actuator, the motion assisting device comprising a first index value measuring means which measures a first index value indicating a remaining energy amount of the electrical storage device and a power regulation means which regulates the motive power of the electric actuator after the time point of measuring the first index value at least according to the first index value measured by the first index value measuring means (First invention).

According to the first invention, the first index value indicating the remaining energy amount of the electrical storage device is measured. Further, the motive power of the electric actuator after the time point of measuring the first index value is regulated at least according to the first index value, and therefore the motive power of the electric actuator is able to be regulated according to the remaining energy in the electrical storage device. For this reason, it is possible to prevent a situation where the remaining energy in the electrical storage device runs out during the operation of the motion assisting device and thereby the electric actuator is not able to operate.

In the first invention, for example, so-called SOC (state of charge), DOD (depth of discharge), or the like is used as the first index value. Moreover, a battery or a capacitor is used as the electrical storage device.

In a more specific example according to the first invention described above, data which defines desired operating time from the start of operation of the motion assisting device (for example, a value of the desired operating time itself, a combination of the start time and the end time or the interruption time of the operation of the motion assisting device, or the like) is preset to the power regulation means. In such cases, preferably the power regulation means regulates the motive power of the electric actuator after the time point of measuring the first index value according to the measured first index value and the remaining operating time which is a period of time from the time point of measuring the first index value to the end time point of the desired operating time so that the remaining energy amount of the electrical storage device is maintained at a predetermined lower limit or greater during the period of time from the time point of measuring the first index value to the end time point of the desired operating time (Second invention).

According to the second invention, the motive power of the electric actuator after the time point of measuring the first index value is regulated according to the measured first index value and the remaining operating time which is a period of time from the time point of measuring the first index value to the end time point of the desired operating time so that the remaining energy amount of the electrical storage device is maintained at a predetermined lower limit or greater during the period of time from the time point of measuring the first index value to the end time point of the desired operating time. Therefore, it is possible to prevent the remaining energy amount of the electrical storage device from being less than the lower limit until the end time point of the desired operating time. Consequently, it is possible to prevent the remaining energy in the electrical storage device from running out within the desired operating time so as to enable the continuous operation of the motion assisting device during the desired operating time.

In the second invention, the description “the remaining energy amount of the electrical storage device is maintained at a predetermined lower limit or greater during the period of time from the time point of measuring the first index value to the end time point of the desired operating time” is equivalent to a description “an actual total energy consumption (energy release amount) of the electrical storage device during the period of time from the time point of measuring the first index value to the end time point of the desired operating time (the time point of an elapse of the remaining operating time) stays within an energy amount of a difference between the remaining energy amount at the time point of measuring the first index value and the predetermined lower limit.” In other words, the description “the remaining energy amount of the electrical storage device is maintained at a predetermined lower limit or greater during the period of time from the time point of measuring the first index value to the end time point of the desired operating time” is equivalent to a description “an actual average energy consumption per unit time (a value obtained by dividing the foregoing total energy consumption by the remaining operating time) of the electrical storage device during the period of time from the time point of measuring the first index value to the end time point of the desired operating time stays within a value obtained by dividing the energy amount of the difference between the remaining energy amount at the time point of measuring the first index value and the predetermined lower limit by the remaining operating time.”

In the second invention, more specifically, for example, the first index value measuring means sequentially measures the first index value after the start of operation of the motion assisting device, and the power regulation means includes a second index value calculation means which calculates a second index value indicating a change pattern over time of the remaining energy amount of the electrical storage device predicted after the time point of measuring the latest first index value in the time series of the first index value on the basis of the time series of the measured first index value and a desired second index value determining means which determines a desired second index value which is a desired value of the second index value requested in order to make the remaining energy amount of the electrical storage device at the end time point of the desired operating time coincide with the predetermined lower limit on the basis of the latest first index value and the remaining operating time from the time point of measuring the latest first index value, and at least in the case where the remaining energy amount of the electrical storage device at the end time point of the desired operating time predicted from the second index value calculated by the second index value calculation means (hereinafter, also referred to as the end-time predicted remaining energy amount in some cases) is less than the predetermined lower limit, the motive power of the electric actuator is regulated so that the second index value calculated by the second index value calculation means is brought close to the desired second index value determined by the desired second index value determining means (Third invention).

According to the third invention, at least in the case where the end-time predicted remaining energy amount is less than the predetermined lower limit, the motive power of the electric actuator is regulated so that the second index value calculated by the second index value calculation means is brought close to the desired second index value determined by the desired second index value determining means. In this case, the desired second index value is a desired value of the second index value requested to make the remaining energy amount of the electrical storage device at the end time point of the desired operating time coincide with the predetermined lower limit, and therefore it is possible to maintain the remaining energy amount of the electrical storage device during the period of time from the time point of measuring the first index value to the end time point of the desired operating time at the predetermined lower limit or greater.

In the third invention, the second index value may be, for example, an average rate of change per unit time of the first index value, average energy consumption per unit time of the electrical storage device, an average energy release amount per unit time of the electrical storage device, or the like.

In the third invention, more specifically, for example, the power regulation means further includes a power regulation control input determining means, which determines a control input for regulating the motive power of the electric actuator according to a feedback control law so as to bring a deviation between the determined desired second index value and the calculated second index value close to “0” according to the deviation, and the power regulation means regulates the motive power of the electric actuator according to the control input while limiting the motive power of the electric actuator so that the assisting force generated in the assisting force transmitting portion stays within a predetermined upper limit (Fourth invention).

According to the fourth invention, the control input determined by the power regulation control input determining means has a function of regulating the motive power of the electric actuator so as to bring the second index value calculated by the second index value calculation means close to the desired second index value which has been determined and consequently so as to bring the end-time predicted remaining energy amount close to the predetermined lower limit. Therefore, in the situation where the end-time predicted remaining energy amount is less than the predetermined lower limit, the control input functions so as to adjust the energy consumption of the electrical storage device by the electric actuator in the decreasing direction and further so as to maintain the remaining energy amount of the electrical storage device during the period of time from the time point of measuring the first index value to the end time point of the desired operating time at the predetermined lower limit or greater.

On the other hand, in a situation where the end-time predicted remaining energy amount is greater than the predetermined lower limit, the control input has a function of adjusting the energy consumption of the electrical storage device by the electric actuator in the decreasing direction. Therefore, if the motive power of the electric actuator is adjusted according to the control input without limitation on the motive power of the electric actuator, the motive power and consequently the assisting force could be too excessive. Therefore, in the fourth invention, the motive power of the electric actuator is regulated according to the control input while limiting the motive power of the electric actuator so that the assisting force generated in the assisting force transmitting portion stays within the predetermined upper limit. Thereby, it is possible to prevent the motive power of the electric actuator and consequently the assisting force from being excessive in the situation where the end-time predicted remaining energy amount is greater than the predetermined lower limit.

In order to regulate the motive power of the electric actuator according to the control input while limiting the motive power of the electric actuator as described above, the motive power of the electric actuator is forcibly limited to the upper limit, for example, in the case where a requested value of the motive power of the electric actuator provided according to the control input exceeds the predetermined upper limit.

In the fourth invention, in the case where the feedback control law is a feedback control law having an integral term of the deviation as a component of the control input (for example, a PI control law or a PID control law), preferably the power regulation means stops an update of a value of the integral term by the power regulation control input determining means in the case where the limitation on the motive power of the electric actuator causes the assisting force generated in the assisting force transmitting portion to be set to the predetermined upper limit (Fifth invention).

More specifically, in the fourth invention, the motive power of the electric actuator is forcibly limited in a situation where the end-time predicted remaining energy amount is greater than the predetermined lower limit. Accordingly, if the update of the integral term value is continued in the situation, the integral term value is easily excessive. Moreover, if the integral term is excessive, the control input is delayed in shifting to a control input in the decreasing direction of the motive power of the electric actuator in the case of a shift to a situation where the end-time predicted remaining energy amount is reduced to lower than the predetermined lower limit. As a result, the suppression of the energy consumption of the electrical storage device is delayed.

Therefore, in the fifth invention, an update of a value of the integral term by the power regulation control input determining means is stopped in the case where the limitation on the motive power of the electric actuator causes the assisting force generated in the assisting force transmitting portion to be set to the predetermined upper limit. Thereby, it is possible to prevent the value of the integral term from being excessive in the case where the motive power of the electric actuator is forcibly limited in a situation where the end-time predicted remaining energy amount is greater than the predetermined lower limit. Therefore, in the case of a shift to a situation where the end-time predicted remaining energy amount is reduced to lower than the predetermined lower limit, it is possible to immediately regulate the motive power of the electric actuator in the decreasing direction according to the control input. Accordingly, it is possible to suppress the energy consumption of the electrical storage device immediately.

### BRIEF DESCRIPTION OF THE DRAWINGS

FIG. 1 is a perspective view of a motion assisting device according to an embodiment of the present invention;

FIG. 2 is a side view of the motion assisting device according to the embodiment of the present invention;

FIG. 3 is a front view of the motion assisting device according to the embodiment of the present invention;

FIG. 4 is a cross-sectional side view of a thigh frame of the motion assisting device;

FIG. 5 is a block diagram illustrating the outline of a hardware configuration of a controller provided in the motion assisting device;

FIG. 6 is a block diagram illustrating processing functions of an arithmetic processing unit of the controller shown in FIG. 5;

FIG. 7 is a block diagram illustrating the processing of a left/right desired share determining means shown in FIG. 6;

FIG. 8 is a block diagram illustrating the process of step S100 shown in FIG. 7;

FIG. 9 is a graph for describing the process of the step S100 shown in FIG. 7;

FIG. 10 is a flowchart illustrating the process of step S101 shown in FIG. 7;

FIG. 11 is a diagram typically illustrating the construction of an essential part of a leg link of the motion assisting device according to the embodiment of the present invention; and

FIG. 12 is a block diagram illustrating processing functions of an indicator current determining means shown in FIG. 6.

### DETAILED DESCRIPTION OF THE PREFERRED EMBODIMENTS

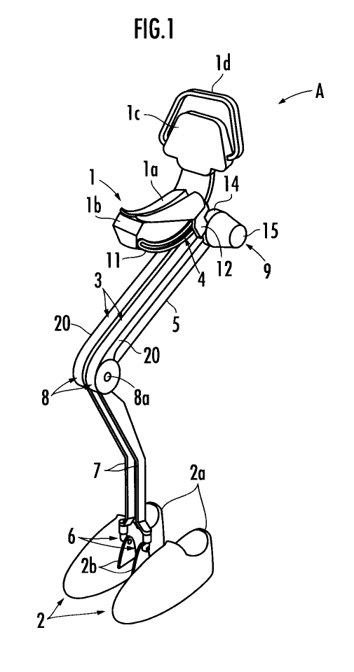

One embodiment of the present invention will be described in detail hereinafter. First, a mechanical configuration of a motion assisting device according to this embodiment will be described with reference to FIGS. 1 to 4.

A motion assisting device A according to this embodiment reduces load on the legs of a user P by supporting a part of the body weight of the user P. As shown, the motion assisting device A includes a seating portion 1 as an assisting force transmitting portion, a pair of right and left foot attachment portions 2 and 2 attached to the feet of the legs of the user P, and a pair of right and left leg links 3 and 3 respectively connecting the foot attachment portions 2 and 2 to the seating portion 1. The right and left foot attachment portions 2 and 2 have the symmetrically same structure. The right and left leg links 3 and 3 have the symmetrically same structure, too.

Each leg link 3 is composed of a thigh frame 5 extended downward from the seating portion 1 through a first joint 4, a crus frame 7 extended upward from each foot attachment portion 2 through a second joint 6, and a third joint 8 bendably connecting the thigh frame 5 and the crus frame 7 in the middle between the first joint 4 and the second joint 6.

Further, the motion assisting device A includes an electric actuator 9 which generates a driving force for driving the third joint 8 for each leg link 3 and a power transmission system 10 which transmits the driving force of the electric actuator 9 to the third joint 8 to apply a driving torque around the joint axis to the third joint 8.

The seating portion 1 is composed of a saddle-shaped seat 1a, on which the user P sits in a straddling manner (so that the seat 1a is put between the root ends of the legs of the user P), a support frame 1b attached to the lower surface of the seat la, and a hip pad 1c mounted at the rear end portion (a rising portion which rises at the rear of the seat 1a) of the support frame 1b. Further, the hip pad 1c is provided with an arcuate handle 1d which can be grasped by the user P or an attendant.

In the seating portion 1 configured as described above, the user P sits on the seat 1a in a straddling manner, by which the top surface of the seat 1a comes in contact with a region (the crotch region) between the root ends of the legs of the user P. In this state, it is possible to apply an upward assisting force (translational force) to the trunk of the user P from the seating portion 1 by biasing the seating portion 1 upward.

Although the assisting force transmitting portion is formed by the seating portion 1 having the saddle-shaped seat 1a in this embodiment, the assisting force transmitting portion may be formed by, for example, a harness-shaped flexible member. In the motion assisting device which supports a part of the body weight of the user P, preferably the assisting force transmitting portion includes a portion in contact with the user P between the root ends of the legs in order to apply an upward assisting force (hereinafter, referred to as the lifting force in some cases) to the trunk of the user P.

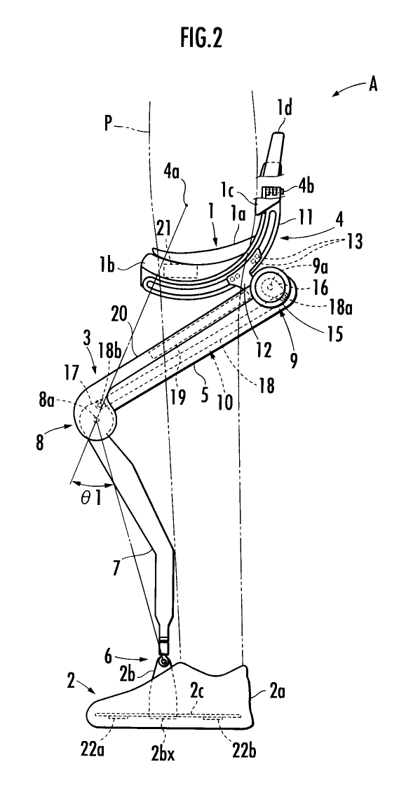

The first joint 4 of each leg link 3 has degrees of freedom of rotation (two degrees of freedom) around two joint axes in the longitudinal direction and the lateral direction. More specifically, each first joint 4 includes an arcuate guide rail 11 connected to the seating portion 1. Further, a slider 12 secured to the upper end portion of the thigh frame 5 of each leg link 3 is movably engaged with the guide rail 11 through a plurality of rollers 13 pivotally attached to the slider 12. This enables each leg link 3 to make a swing motion in the longitudinal direction (longitudinal rocking motion) around a first joint axis of the first joint 4, where the first joint axis is a lateral axis passing through a curvature center 4a (See FIG. 2) of the guide rail 11 (more specifically, an axis perpendicular to the plane including the arc of the guide rail 11).

Moreover, the guide rail 11 is pivotally supported by the rear end portion (the rising portion) of the support frame 1b of the seating portion 1 through a spindle 4b whose central axis is directed in the longitudinal direction so as to be swingable around the central axis of the spindle 4b. This allows each leg link 3 to make a lateral swing motion around the second joint axis, namely, an adduction/abduction motion, with the central axis of the spindle 4b as the second joint axis of the first joint 4. In this embodiment, the second joint axis of the first joint 4 is a common joint axis between the first joint 4 on the right side and the first joint 4 on the left side.

As described above, the first joint 4 is adapted to enable each leg link 3 to make swing motions around two joint axes in the longitudinal direction and in the lateral direction.

The number of degrees of freedom of rotation of the first joint is not limited to two. For example, the first joint may be adapted to have degrees of freedom of rotation around three joint axes (three degrees of freedom). Alternatively, for example, the first joint may be adapted to have only a degree of freedom of rotation around one joint axis in the lateral direction (one degree of freedom).

Each foot attachment portion 2 has a shoe 2a worn on each foot of the user P and a connection member 2b which projects upward from the inside of the shoe 2a. The foot attachment portion 2 comes in contact with the floor through the shoe 2a in a state where the leg of the user is a standing leg (supporting leg). Further, the lower end portion of the crus frame 7 of each leg link 3 is connected to the connection member 2b through the second joint 6.

In this instance, the connection member 2b integrally has a flat-plate portion 2bx disposed on the underside of an insole 2c in the shoe 2a (between the bottom of the shoe 2a and the insole 2c) as shown in FIG. 2. Further, the connection member 2b is formed by a relatively highly rigid member including the flat-plate portion 2bx so as to enable a part of the floor reaction force acting on the foot attachment portion 2 from the floor (a translational force at least enough to support the weight obtained by adding the weight of the motion assisting device A to a part of the body weight of the user P) to act on the leg link 3 through the connection member 2b and the second joint 6 when the foot attachment portion 2 is placed on the floor.

The foot attachment portion 2 may include, for example, a slipper-shaped member, instead of the shoe 2a.

The second joint 6 is composed of a free joint such as a ball joint and has degrees of freedom of rotation around three axes in this embodiment. The second joint, however, may be a joint having degrees of freedom of rotation, for example, around two axes in the longitudinal direction and the lateral direction or around two axes in the vertical direction and in the lateral direction.

The third joint 8 has a degree of freedom of rotation around one axis in the lateral direction and has a spindle 8a pivotally supporting the upper end portion of the crus frame 7 in the lower end portion of the thigh frame 5. The central axis of the spindle 8a is substantially parallel to the first joint axis (the axis perpendicular to the plane including the arc of the guide rail 11) of the first joint 4. The central axis of the spindle 3a is the joint axis of the third joint 8. The crus frame 7 is relatively rotatable with respect to the thigh frame 5 around the joint axis of the third joint 8. This allows the leg link 3 to make bending and stretching motions at the third joint 8.

The electric actuator 9 for each leg link 3 is a rotary actuator composed of an electric motor 15 with a speed reducer 14. The electric actuator 9 is mounted on the outer surface of the upper end portion (a portion near the first joint 4) of the thigh frame 5 so that the central axis of an output shaft 9a is parallel to the joint axis of the third joint 8 (the central axis of the spindle 8a). Further, a housing of the electric actuator 9 (a portion secured to a stator of the electric motor 15) is provided in a fixed manner to the thigh frame 5.

Each power transmission system 10 includes a drive crank arm 16 coaxially secured to the output shaft 9a of the electric actuator 9, a driven crank arm 17 secured to the crus frame 7 coaxially with the joint axis of the third joint 8, and a connecting rod 18 whose one end and the other end are pivotally mounted on the drive crank arm 16 and the driven crank arm 17, respectively. The connecting rod 18 linearly extends between a pivotally mounted portion 18a for the drive crank arm 16 and a pivotally mounted portion 18b for the driven crank arm 17.

In the power transmission system 10 configured as described above, a driving force (output torque) output from the output shaft 9a of the electric actuator 9 by the operation of the electric motor 15 is converted to a lengthwise translational force of the connecting rod 18 through the drive crank arm 16 from the output shaft 9a. Then, the translational force (rod transmitting force) is transmitted through the connecting rod 18 in its lengthwise direction. Further, the translational force is converted to a driving torque through the driven crank arm 17 from the connecting rod 18 and the driving torque is applied to the third joint 8 as a driving force for bending and stretching the leg link 3 around the joint axis of the third joint 8.

In this embodiment, the total sum of the lengths of the thigh frame 5 and the crus frame 7 of each leg link 3 is longer than the length of the linearly stretched leg of the user P. Therefore, each leg link 3 always bends at the third joint 8. A bending angle θ1 (see FIG. 2) of the leg link 3 ranges, for example, from approx. 40 to 70 degrees during normal walking of the user P on level ground. The bending angle θ1 here means an angle (an angle on the acute angle side) made by a line between the third joint 8 and a curvature center 4a of the guide rail 11 and a line between the third joint 8 and the second joint 6, when each leg link 8 is viewed in the joint axis direction of the third joint 8, as shown in FIG. 2.

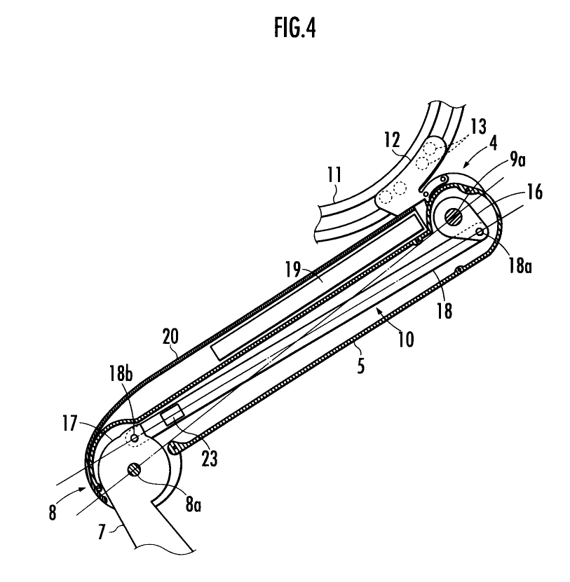

In this embodiment, a relative positional relationship between the pivotally mounted portions 18a and 18b of the connecting rod 18, the joint axis of the third joint 8, and the output shaft 9a of the electric actuator 9 is set so that the driving torque applied to the third joint 8 is greater than the output torque of the electric actuator 9 in a state where the bending angle θ1 of each leg link 3 is in a certain angle range (for example, a range of approx. 20 to 70 degrees) including an angle range for normal walking of the user P on level ground. In this case, when each leg link 3 is viewed in the joint axis direction of the third joint 8, the line connecting the output shaft 9a of the electric actuator 9 with the third joint 8 obliquely intersects with the line connecting the pivotally mounted portion 18a of the connecting rod 18 with the pivotally mounted portion 18b thereof as shown in FIG. 4 in this embodiment.

Further, in this embodiment, the position of the pivotally mounted portion 18b of the connecting rod 18 is set so that the driving torque applied to the third joint 8 acts as a torque for biasing the leg link 3 in the stretching direction when the electric actuator 9 applies a tractive force to the connecting rod 18 in the lengthwise direction thereof in a state where the bending angle θ1 of each leg link 3 is in a certain angle range (for example, a range of approx. 20 to 70 degrees) including an angle range for normal walking of the user P on level ground. In this case, the pivotally mounted portion 18b of the connecting rod 18 is disposed on the guide rail 11 side from the line connecting the output shaft 9a of the electric actuator 9 with the third joint 8 when each leg link 3 is viewed in the joint axis direction of the third joint 8 in this embodiment.

Moreover, as shown in FIG. 4, the thigh frame 5 is equipped with a battery (secondary battery) 19 as an electrical storage device disposed between the connecting rod 18 and the guide rail 11 and a cover 20 which covers the battery 19. The battery 19 is a power supply for electric devices including the electric motor 15 and the like.

In this embodiment, the battery 19 is mounted on each of the thigh frames 5 and 5. These batteries 19 and 19 are connected in series or in parallel by connecting wires, which are not shown, and used as power supplies shared among the electric devices including the electric motors 15 and 15. Therefore, in the subsequent description, it is assumed that the term “battery 19” means the entire battery including the two batteries 19 and 19.

More specifically, the electrical storage device may be a capacitor such as an electric double layer capacitor (including a combination of a plurality of capacitor elements) as long as the capacitor is able to store energy equivalent to the energy of the battery 19. Further, the electrical storage device may be formed by combining a battery and a capacitor.

The above is the main mechanical configuration of the motion assisting device A according to this embodiment. In the motion assisting device A configured as described above, the seating portion 1 is biased upward by applying a driving force (driving torque) in the stretching direction to the third joint 8 of the leg link 3 from the electric actuator 9 through the power transmission system 10 with each foot attachment portion 2 on the floor. Thereby, an assisting force (lifting force) to be an upward translational force acts on the user P from the seating portion 1. The motion assisting device A according to this embodiment supports a part of the body weight of the user P (a part of the gravity acting on the user P) by the lifting force to reduce load on the legs during walking of the user P or in bending and stretching of the legs.

In this case, the motion assisting device A bears the share of the supporting force for supporting the motion assisting device A itself and a part of the body weight of the user P on the floor out of the supporting force for supporting the total weight of the motion assisting device A and the user P on the floor (the total translational force acting on the supporting surface of the motion assisting device A from the floor: hereinafter, referred to as the total supporting force), and the user P bears the share of the remaining supporting force. Hereinafter, in the total supporting force, the supporting force as the share born by the motion assisting device A is referred to as the assisting device share supporting force, and the supporting force as the share born by the user P is referred to as the user share supporting force. The assisting device share supporting force acts on both of the leg links 3 and 3 in a distributed manner in a state where the legs of the user P are standing legs. In a state where only one leg is a standing leg, the assisting device share supporting force acts on only one leg link 3 on the one leg side of the leg links 3 and 3. The same applies to the user share supporting force.

Although not shown, a spring (not shown) for biasing each leg link 3 in the stretching direction is attached between the third joint 8 of each leg link 3 or the thigh frame 5 and the crus frame 7 in order to reduce load on the electric actuator 9 (reduce the required maximum output torque) in this embodiment. The spring, however, may be omitted.

Subsequently, the configuration for motion control of the motion assisting device A according to this embodiment will be described with reference to FIGS. 1 to 4, 5, and 6.

In the motion assisting device A according to this embodiment, a controller 21 (control unit) which performs the motion control of the electric motor 15 of each electric actuator 9 is housed in the support frame 1b of the seating portion 1 as shown in FIG. 2.

Further, the motion assisting device A is equipped with sensors described below and outputs of the sensors are input to the controller 21. As shown in FIG. 2, a pair of treading force measurement force sensors 22a and 22b for use in measuring a treading force of each leg of the user P (a vertical translational force of pressing the foot of each leg toward the floor) are disposed in the shoe 2a of each foot attachment portion 2.

The treading force of each leg is, in other words, a translational force which is balanced with a force acting on each leg (the share of each leg) of the user share supporting force, and the magnitude of the total sum of the treading forces of the legs is equal to the magnitude of the user share supporting force. In this embodiment, the treading force measurement force sensors 22a and 22b are attached to the undersurface of the insole 2c in the shoe 2a so as to be opposed to the bottom surface of the foot of the user P at two places at the front and back, namely a place directly beneath metatarsophalangeal joints (MP joints) and a place directly beneath the heel of a foot of the user P. Each of the treading force measurement force sensors 22a and 22b is formed by a one-axis force sensor and generates an output depending on the translational force in the direction perpendicular to the bottom surface of the shoe 2a.

Moreover, as shown in FIG. 4, a strain gauge force sensor 23 is attached at a place near the third joint 8 of the connecting rod 18 of each power transmission system 10. The strain gauge force sensor 23 is a well-known sensor composed of a plurality of strain gauges (not shown) secured to the outer peripheral surface of the connecting rod 18 and generates output depending on the translational force acting on the connecting rod 18 in its lengthwise direction. The strain gauge force sensor 23 has high sensitivity to the lengthwise translational force of the connecting rod 18. Moreover, the strain gauge force sensor 23 has sufficiently small sensitivity to a force in the shear direction (transverse direction) of the connecting rod 18.

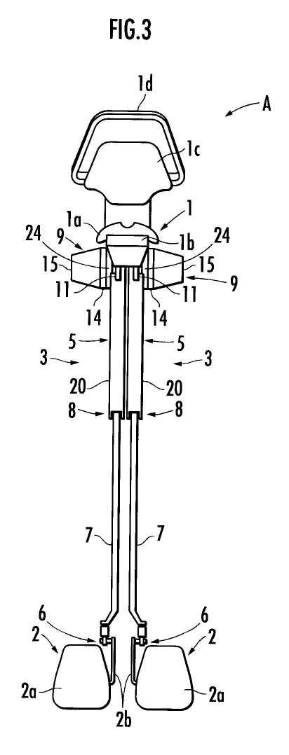

Moreover, an angle sensor 24 (shown in FIG. 3), such as a rotary encoder which generates output depending on a rotation angle (a rotation angle from the reference position) of the output shaft 9a of each electric actuator 9, is mounted on the thigh frame 5 integrally with the electric actuator 9 in order to measure the bending angle of each leg link 3 which represents a displacement angle (a relative rotation angle of the crus frame 7 from the reference position with respect to the thigh frame 5) of the third joint 8 of each leg link 3. In this embodiment, the bending angle at the third joint 8 of each leg link 3 is uniquely determined according to the rotation angle of the output shaft 9a of each electric actuator 9. Therefore, the angle sensor 24 generates output depending on the bending angle of each leg link 3. The third joint 8 of each leg link 3 corresponds to a knee joint, and therefore the bending angle of each leg link 3 at the third joint 8 is referred to as the knee angle in the following description.

Additionally, an angle sensor such as a rotary encoder may be mounted on the third joint 8 of each leg link 3 so as to measure the knee angle of each leg link 3 directly by using the angle sensor.

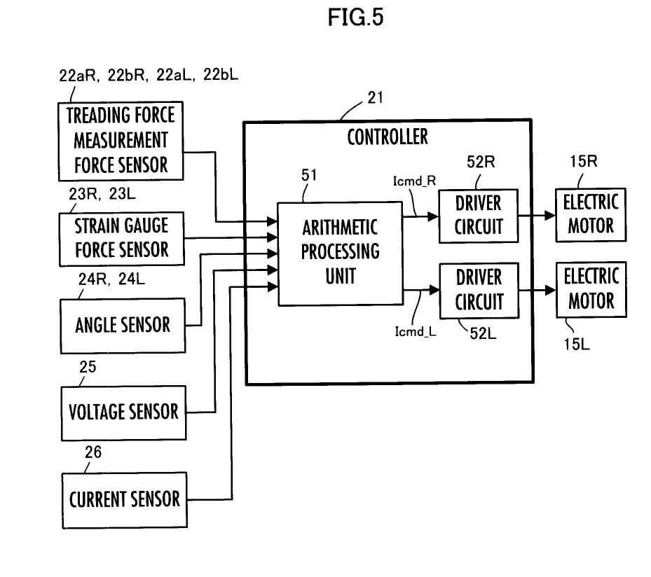

Further, as sensors for measuring the state of charge (SOC) as a first index value indicating a remaining energy amount (remaining capacity) of the battery 19, a voltage sensor 25 and a current sensor 26 (shown in FIG. 5), which detect a terminal-to-terminal voltage (a voltage between the positive terminal and the negative terminal) of the battery 19 and a current which flows through the battery 19, respectively, are mounted on proper places (for example, the thigh frame 5) of the motion assisting device A.

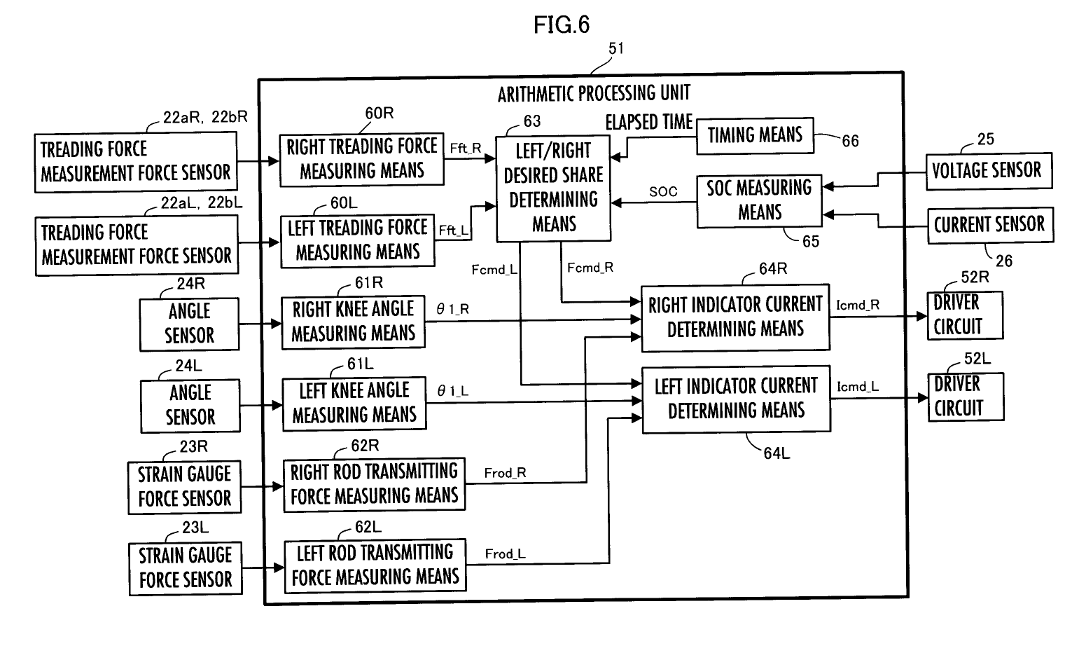

Subsequently, the functions of the controller 21 will be described in more detail with reference to FIGS. 5 and 6. In the following description, a character “R” or “L” may be added at the end of a reference numeral in order to distinguish between right and left in some cases. For example, the leg link 3 on the right-hand side in the forward direction of the user P is denoted by “leg link 3R” and the leg link 3 on the left-hand side in the forward direction of the user P is denoted by “leg link 3L.” The character “R” or “L” at the end of each reference numeral is used to mean “relating to the leg link 3R on the right-hand side” or “relating to the leg link 3L on the left-hand side.”

As shown in FIG. 5, the controller 21 includes an arithmetic processing unit 51 and driver circuits 52R and 52L which energize the electric motors 15R and 15L for the electric actuators 9R and 9L, respectively.

The arithmetic processing unit 51 is formed by a micro computer including a CPU, a RAM, and a ROM. The arithmetic processing unit 51 receives outputs from the treading force measurement force sensors 22aR, 22bR, 22aL, and 22bL, outputs from the strain gauge force sensors 23R and 23L, outputs from the angle sensors 24R and 24L, and outputs from the voltage sensor 25 and the current sensor 26 entered through an interface circuit (not shown) which is composed of an A/D converter and the like.

Then, the arithmetic processing unit 51 performs required arithmetic processing by using input detection data and previously-stored reference data and programs and determines indicator current values Icmd_R and Icmd_L which are indicator values (desired values) of the applied current of the electric motors 15R and 15L. Further, the arithmetic processing unit 51 controls the driver circuits 52R and 52L to apply the currents of the indicator current values Icmd_R and Icmd_L to the electric motors 15R and 15L, respectively. Thereby, the output torques of the electric motors 15R and 15L and consequently the output torques of the electric actuators 9R and 9L are controlled.

The arithmetic processing unit 51 has functional means as illustrated in the block diagram of FIG. 6 in order to determine the indicator current values Icmd_R and Icmd_L. The functional means are implemented by the program installed in the arithmetic processing unit 51.

As shown in FIG. 6, the arithmetic processing unit 51 includes a right treading force measuring means 60R which measures the treading force of the right leg of the user P on the basis of the outputs from the right treading force measurement force sensors 22aR and 22bR, a left treading force measuring means 60L which measures the treading force of the left leg of the user P on the basis of the outputs from the left treading force measurement force sensors 22aL and 22bL, a right knee angle measuring means 61R which measures the knee angle of the leg link 3R on the basis of the output from the right angle sensor 24R, a left knee angle measuring means 61L which measures the knee angle of the leg link 3L on the basis of the output from the left angle sensor 24L, a right rod transmitting force measuring means 62R which measures a rod transmitting force (a translational force acting in the lengthwise direction of the connecting rod 18R) acting on the connecting rod 18R of the power transmission system 10R on the basis of the output from the right strain gauge force sensor 23R, a left rod transmitting force measuring means 62L which measures a rod transmitting force (a translational force acting in the lengthwise direction of the connecting rod 18L) acting on the connecting rod 18L of the power transmission system 10L on the basis of the output from the left strain gauge force sensor 23L, an SOC measuring means 65 which measures the SOC of the battery 19 on the basis of the output from the voltage sensor 25 and the current sensor 26, and a timing means 66 which measures an elapsed time. In this embodiment, the SOC corresponds to the first index value according to the present invention. Therefore, the SOC measuring means 65 corresponds to the first index value measuring means according to the present invention.

More specifically, there are generally used various forms of expression for an SOC value such as, for example, an expression on the dimension of energy (an expression in units of [J] or [W·h]), an expression on the dimension of the amount of charge (an expression in units of [C] or [A·h]), an expression by a relative ratio of the battery 19 in a fully charged state relative to a capacitance value (rated capacity) (an expression as a percentage [%] etc.) and the like. The SOC according to this embodiment may be any of these forms of expression. In the following description, however, it is assumed that the SOC of this embodiment is expressed by a relative ratio [%] of the battery 19 relative to a rated capacity for convenience.

Moreover, the arithmetic processing unit 51 includes left/right desired share determining means 63 which determines desired values Fcmd_R and Fcmd_L of the shares of the leg links 3R and 3L out of the assisting device share supporting force. The left/right desired share determining means 63 receives values (measured values) Fft_P and Fft_L of the right and left treading forces measured by the treading force measuring means 60R and 60L, the SOC measured by the SOC measuring means 65, and the elapsed time measured by the timing means 66 in order to determine the desired values Fcmd_R and Fcmd_L.

More specifically, the total sum of the supporting forces (hereinafter, referred to as the total lifting force) acting on the leg links 3R and 3L from the floor side through the second joints 6R and 6L, respectively, is more accurately equal to a value obtained by subtracting supporting forces for supporting the foot attachment portions 2R and 2L on the floor from the assisting device share supporting force. In other words, the total lifting force has a meaning of an upward translational force (an assisting force) for supporting parts other than the foot attachment portions 2R and 2L of the motion assisting device A and a part of the body weight of the user P. The total weight of the foot attachment portions 2R and 2L, however, is sufficiently small in comparison with the total weight of the motion assisting device A and therefore the total lifting force substantially coincides with the assisting device share supporting force. In the following description, the shares of the leg links 3R and 3L out of the assisting device share supporting force are referred to as total lifting force shares. In addition, the desired values Fcmd_R and Fcmd_L of the total lifting force shares of the leg links 3R and 3L are referred to as leg link share desired values Fcmd_R and Fcmd_L.

The arithmetic processing unit 51 includes a right indicator current determining means 64R, which determines an indicator current value Icmd_R of the electric motor 15R on the basis of a measured value Frod_R of a rod transmitting force of the connecting rod 18R measured by the right rod transmitting force measuring means 62R, a right leg link share desired value Fcmd_R determined by the left/right desired share determining means 63, and a measured value θ1_R of a knee angle of the leg link 3R measured by the right knee angle measuring means 61R, and a left indicator current determining means 64L, which determines an indicator current value Icmd_L of the electric motor 15L on the basis of a measured value Frod_L of a rod transmitting force of the connecting rod 18L measured by the left rod transmitting force measuring means 62L, a left leg link share desired value Fcmd_L determined by the left/right desired share determining means 63, and a measured value θ1_L of a knee angle of the leg link 3L measured by the left knee angle measuring means 61L.

Subsequently, the processing of the arithmetic processing unit 51 will be described in detail. The following description is made taking an example of a case where the user P as a worker uses the motion assisting device A in working in the job site such as, for example, a factory.

Before starting the work, the controller 21 is turned on. In this case, the power of the controller 21 is supplied, for example, from the battery 19 through a DC/DC converter which is not shown or from a battery (not shown) for the controller 21. In this state, data which defines desired operating time of the motion assisting device A from the start of the work (the start of the operation of the motion assisting device A) is input to the controller 21 through an operating device which is not shown. The input data is, for example, a value of the desired operating time itself or a pair of a work start time and a work end time (or a work interruption time). Then, the controller 21 determines the desired operating time of the motion assisting device A according to the input data and stores the desired operating time in a memory which is not shown. A standard desired value of the total lifting force is also set for the controller 21 before starting the work, and the standard desired value will be described later.

Then, at the start of the work, a start command for the motion assisting device A is input from a switch or the like, which is not shown, to the controller 21, with the foot attachment portions 2 attached to the feet of the user P and with the seating portion 1 put under the crotch of the user P. In this condition, the battery 19 is ready to supply electric power for the operation to the electric motors 15 through the driver circuits 52. Then, the arithmetic processing unit 51 starts to measure an elapsed time by the timing means 66 and starts the operation of the motion assisting device A by performing the processing described below at predetermined control processing cycles.

In each control processing cycle, the arithmetic processing unit 51, first, performs the processing of the treading force measuring means 60R and 60L, the processing of the knee angle measuring means 61R and 61L, the processing of the rod transmitting force measuring means 62R and 62L, and the processing of the SOC measuring means 65. The processing of the knee angle measuring means 61R and 61L and the processing of the rod transmitting force measuring means 62R and 62L may be performed after or in parallel with the processing of the left/right desired share determining means 63 described later.

The processing of the treading force measuring means 60R and 60L is performed as described below. The algorithm of the processing is the same in either of the treading force measuring means 60R and 60L. Therefore, the processing of the right treading force measuring means 60R is typically described below.

The right treading force measuring means 60R obtains a measured value Fft_R of the treading force of the right leg of the user P by adding up force detected values respectively indicated by the outputs of the treading force measurement force sensors 22aR and 22bR (more specifically, force detected values subjected to low-pass characteristic filtering for removing noise components). The same applies to the processing of the left treading force measuring means 60L.

In the processing of the respective treading force measuring means 60, the measured value Fft of the treading force may be forcibly set to “0” if the total sum of the force detected values obtained by the treading force measurement force sensors 22a and 22b corresponding to the respective treading force measuring means 60 is a minute value equal to or less than a predetermined lower limit, or a limiting process may be added to forcibly set the measured value Fft of the treading force to a predetermined upper limit if the total sum exceeds the upper limit. In this embodiment, basically the ratio between the leg link share desired values Fcmd_R and Fcmd_L is determined according to the ratio between the measured value Fft_R of the treading force of the right leg of the user P and the measured value Fft_L of the treading force of the left leg of the user P as described later. Therefore, adding the foregoing limiting process to the processing of the respective treading force measuring means 60 is effective to reduce frequent changes in the ratio between the leg link share desired values Fcmd_R and Fcmd_L.

Moreover, the processing of the knee angle measuring means 61F and 61L is performed as described below. The algorithm of the processing is the same in either of the knee angle measuring means 61R and 61L. Therefore, the processing of the right knee angle measuring means 61R is typically described below. The right knee angle measuring means 61R obtains a provisional measured value of the knee angle of the leg link 3R on the basis of a preset arithmetic expression or data table (an arithmetic expression or data table representing the relationship between the rotation angle and the knee angle of the leg link 3R) from the rotation angle of the output shaft 9aR of the electric actuator 9R indicated by the output from the angle sensor 24R. Then, the right knee angle measuring means 61R obtains a measured value θ1_R of the knee angle of the leg link 3R by applying the low-pass characteristic filtering for removing noise components to the provisional measured value. The same applies to the processing of the left knee angle measuring means 61L.

More specifically, although the knee angle measured by each of the knee angle measuring means 61 may be the angle θ1 shown in FIG. 2, it may also be a supplementary angle (=180°−θ1) of the angle θ1. Alternatively, for example, when viewed in the joint axis direction of the third joint 8 of each leg link 3, it is possible to define an angle, which is made by the lengthwise direction of the thigh frame 5 of each leg link 3 and a line connecting the third joint 8 of the leg link 3 with the second joint 6, as the knee angle. In the following description, it is assumed that the knee angle measured by each knee angle measuring means 61 is the angle θ1 shown in FIG. 2.

Moreover, the processing of the rod transmitting force measuring means 62R and 62L is performed as described below. The algorithm of the processing is the same in either of the rod transmitting force measuring means 62R and 62L. Therefore, the processing of the right rod transmitting force measuring means 62R is typically described below. The right rod transmitting force measuring means 62R converts an input voltage value of the output from the strain gauge force sensor 23R to the measured value Frod_R of the rod transmitting force on the basis of a preset arithmetic expression or data table (an arithmetic expression or data table representing the relationship between the output voltage and the rod transmitting force). The same applies to the processing of the left rod transmitting force measuring means 62L. In this case, it is possible to remove noise components by applying the low-pass characteristic filtering to the output value of each strain gauge force sensor 23 or the measured values Frod of each rod transmitting force.

Further, the processing of the SOC measuring means 65 is performed as described below. In this embodiment, the SOC measuring means 65 reads the current SOC value of the battery 19 from the memory which is not shown at the start of the operation of the motion assisting device A (or immediately after turning on the controller 21). Then, the SOC measuring means 65 sets the read SOC value as an SOC initial value of the current operation of the motion assisting device A. The initial value is a value stored in a nonvolatile memory such as an EEPROM at the end of the previous operation of the motion assisting device A (if the battery 19 is charged after the end of the previous operation of the motion assisting device A, however, at the end of the charging).

Then, the SOC measuring means 65 obtains the accumulated discharge amount of the battery 19 (the total energy discharged from the battery 19) from the start of the operation of the motion assisting device A by sequentially accumulating (integrating) the product (a power value) of the terminal-to-terminal voltage value of the battery 19 represented by the output from the voltage sensor 25 and the current value of the battery 19 represented by the output from the current sensor 26 at predetermined arithmetic processing cycles. In this case, it is assumed that the discharge current is a positive value and the charge current is a negative value, regarding the current values of the battery 19. Moreover, the SOC measuring means 65 sequentially measures the SOC values by subtracting a value [%], which is obtained by dividing the accumulated discharge amount by the rated capacity (a capacitance value in the fully charged state: a capacitance value on the dimension of energy, here) of the battery 19 previously stored in the memory, from the SOC initial value [%].

Although the rated capacity of the battery 19 is expressed in terms of the dimension of energy in this embodiment, the rated capacity may be expressed in terms of the dimension of the amount of charge (the dimension in units of [C], [A·h], or the like). In this case, a current integrated value (namely, the amount of emitted charge from the battery 19) is sequentially calculated, where the current integrated value is obtained by accumulating (integrating) the current values of the battery 19 represented by the outputs from the current sensor 26. Then, the SOC is measured by subtracting a value, which is obtained by dividing the current integrated value by the rated capacity of the battery 19, from the SOC initial value. In this case, the voltage sensor 25 is unnecessary.

Additionally, various methods are known for grasping the remaining energy amount of a battery in general, and any of those methods may be used. Moreover, the substantial remaining energy amount of the battery 19 is susceptible to the temperature of the battery 19. In such cases, the temperature of the battery 19 is detected by using a temperature sensor. Thereafter, a correction process according to the detected temperature may be added to the SOC measurement.

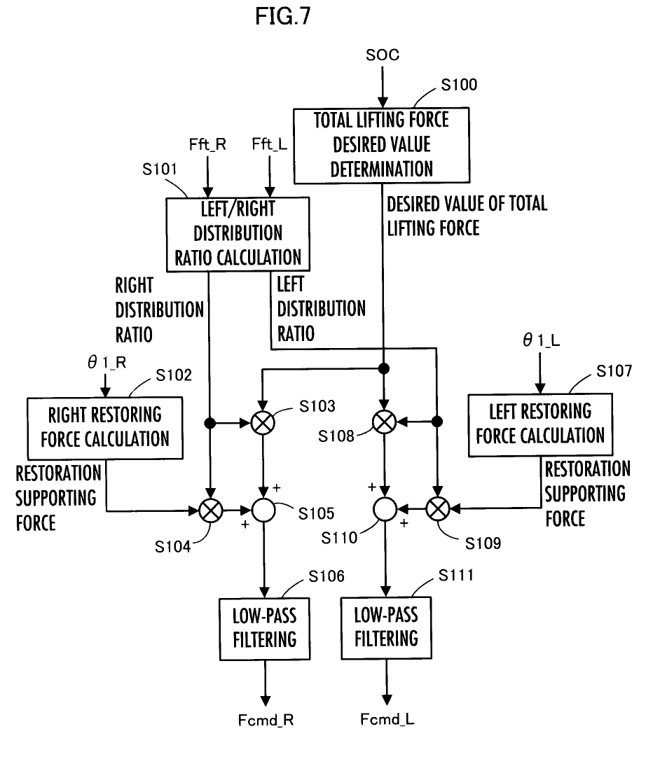

Subsequently, the arithmetic processing unit 51 performs the processing of the left/right desired share determining means 63. This processing will be described in detail below with reference to FIGS. 7 to 9.

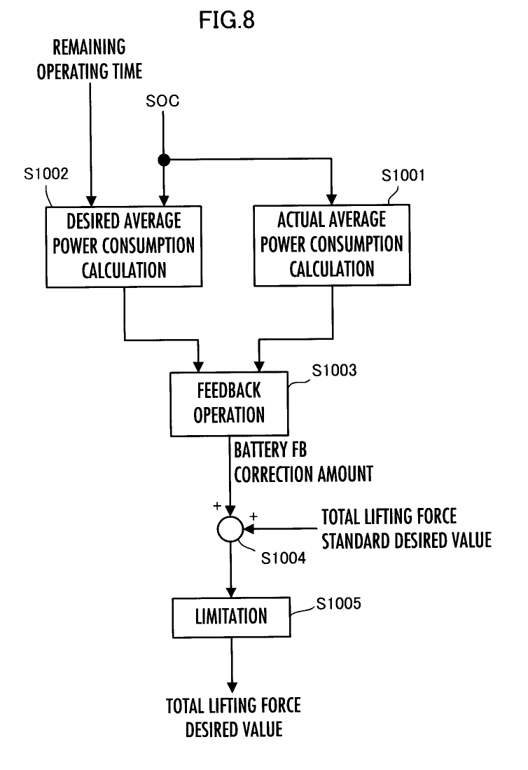

First, the process of the step S100 in FIG. 7 is performed, by which a desired value of the total lifting force (approximately equal to the assisting device share supporting force) is determined. More specifically, referring to FIG. 8, the arithmetic processing unit 51 performs a process of calculating an actual average power consumption, which is an actual average power consumption of the battery 19 around the current time, on the basis of the SOC time series measured up to the current time (the latest value and the past values) by the SOC measuring means 65 in step S1001. The actual average power consumption indicates average energy consumption per unit time of the battery 19 around the current time. The actual average power consumption is calculated, for example, by dividing a difference between a remaining energy amount value of the battery 19 indicated by the SOC value obtained at the time a predetermined time earlier than the current time and a remaining energy amount value of the battery 19 indicated by the SOC value obtained at the current time (hereinafter, simply referred to as the SOC latest value) by the predetermined time. More specifically, the actual average power consumption is calculated by the following equation (1), where ΔT [sec] is the predetermined time, SOC(t−ΔT) [%] is the SOC value obtained at the time the predetermined time ΔT earlier than the current time, SOC(t) [%] is the SOC latest value, and Qmax [J] is the rated capacity of the battery 19:

Actual average power consumption=Qmax·{(SOC(t−ΔT)−SOC(t))/100}/ΔT (1)

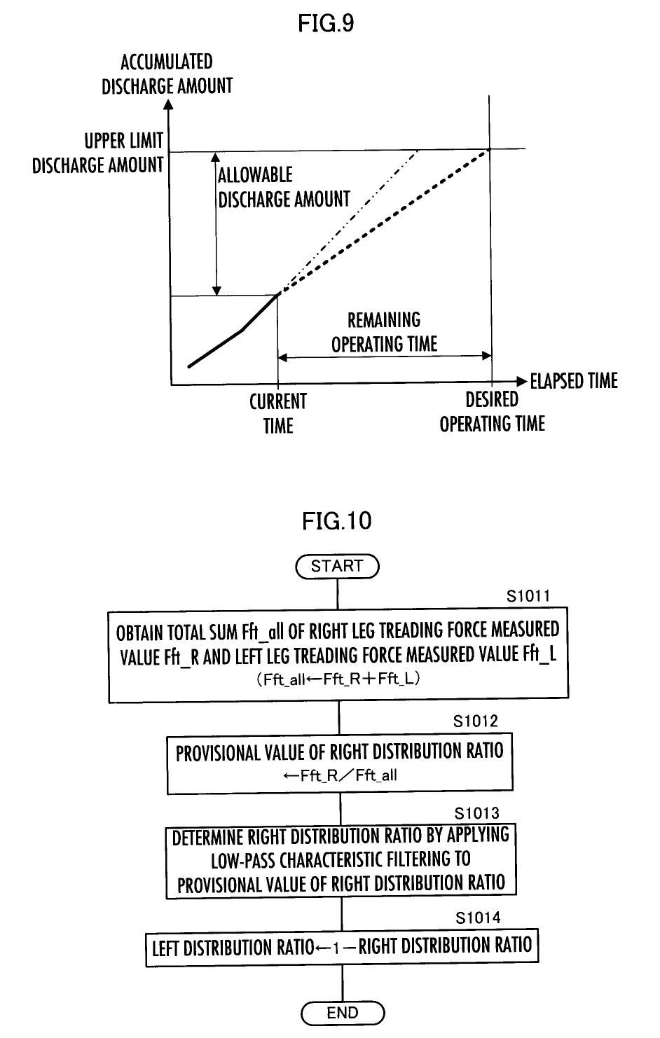

Therefore, for example, as shown by the graph with a solid line in FIG. 9, an average value of the time rate of change in the accumulated discharge amount for a period from the current time back to the predetermined time ΔT ago is obtained as actual average power consumption in the case of a change in the accumulated discharge amount of the battery obtained up to the current time (the total amount of energy of the battery 19 consumed from the start of the operation of the motion assisting device A to the current time). In the example shown in FIG. 9, the actual average power consumption value obtained at the current time is a value obtained from the slope of the graph indicated by a two-dot chain line in FIG. 9.

Additionally, in this embodiment, the actual average power consumption corresponds to a second index value according to the present invention, that is, the second index value indicating a change pattern over time of the remaining energy amount of the battery 19 predicted after the current time. Therefore, the second index value calculation means according to the present invention is implemented by the process of the step S1001.

Further, in step S1002, the arithmetic processing unit 51 performs a process of calculating a desired average power consumption which is a desired value of the average power consumption of the battery 19 after the current time on the basis of the measured SOC latest value and the remaining operating time, which is a period of time obtained by subtracting an elapsed time (an elapsed time up to the current time) measured by the timing means 66 from the desired operating time (that is, a period of time from the current time to the end time of the desired operating time).

The desired average power consumption is determined, for example, as described below. Specifically, first, calculation is made to find an allowable discharge amount, which is an amount of energy dischargeable from the battery 19 until the SOC reaches a predetermined SOC lower limit on the basis of the latest value. Then, the allowable discharge amount is divided by the remaining operating time at the current time, by which the desired average power consumption is determined. More specifically, where SOCmin is the SOC lower limit, the allowable discharge amount is calculated by the following equation (2) by using the rated capacity Qmax described with respect to the equation (1) and the SOC latest value SOC(t). Further, the desired average power consumption is determined by the following equation (3). The SOC lower limit is preset to a value slightly higher than [%] in consideration of the SOC measurement error or the like.

Allowable discharge amount=Qmax·{(SOC(t)−SOCmin)/100} (2)

Desired average power consumption=Allowable discharge amount/Remaining operating time (3)

In this case, in the example shown in FIG. 9, the allowable discharge amount obtained by the equation (2) is a value obtained by subtracting the accumulated discharge amount obtained up to the current time from the upper limit (=Qmax·{(100−SOCmin)/100}) of the accumulated discharge amount corresponding to the SOC lower limit. Then, the desired average power consumption is a value obtained from the slope of the graph indicated by a broken line in FIG. 9.

Additionally, in this embodiment, the desired average power consumption corresponds to a desired value of the second index value indicating a change pattern over time of a remaining energy amount after the current time of the battery 19. Therefore, the desired second index value determining means according to the present invention is implemented by the process of the step S1002. In addition, the lower limit SOCmin according to this embodiment corresponds to the lower limit of the remaining energy amount of the electrical storage device according to the present invention.

Next in step S1003, a battery FB correction amount as a control input of the desired value of the total lifting force is found from the actual average power consumption and the desired average power consumption determined as described above by arithmetic processing of the feedback control law. In this processing, a PI control law is used as the feedback control law. More specifically, the battery FB correction amount is found by adding a proportional term, which is obtained by multiplying a deviation between the desired average power consumption and the actual average power consumption (desired average power consumption—actual average power consumption) by a predetermined proportional gain, to an integral term, which is obtained by multiplying an integral value of the deviation by a predetermined integral gain. Thereby, the battery FB correction amount is determined so that the actual average power consumption gets close to the desired average power consumption.

More specifically, the power regulation control input determining means according to the present invention is implemented by the process of the step S1003 in this embodiment. Further, the battery FB correction amount corresponds to the control input of the present invention.

Next in step S1004, a provisional desired value of the total lifting force is calculated by adding the battery FB correction amount to the total lifting force standard desired value which is a predetermined standard desired value of the total lifting force (by correcting the total lifting force standard desired value by the battery FB correction amount).

Here, the total lifting force standard desired value is set independently of the SOC measured value of the battery 19 (independently of the SOC measured value). In other words, the total lifting force standard desired value is a desired value of the total lifting force set on the assumption that the battery 19 is able to always supply energy required for a desired operation of the electric motors 15 and 15.

In this embodiment, the total lifting force standard desired value is previously set as described below before starting the work and is stored in a memory which is not shown. For example, the entire weight of the motion assisting device A (or the weight obtained by subtracting the total weight of the foot attachment portions 2 and 2 from the entire weight) is added to a part of the body weight of the user P to be supported by the lifting force applied to the user P from the seating portion 1 (for example, the weight obtained by multiplying the entire body weight of the user P by a preset ratio), and the magnitude of gravity (the weight x gravitational acceleration) which acts on the weight obtained by the addition is set as the total lifting force standard desired value. In this case, eventually, an upward translational force of the magnitude equivalent to the gravity acting on the weight of a part of the body weight of the user P is set as the standard desired value of the lifting force from the seating portion 1 to the user P.

Alternatively, the magnitude of the standard desired value of the lifting force from the seating portion 1 to the user P may be enabled to be directly set, so that the total sum of the standard desired value of the lifting force and the magnitude of the gravity acting on the entire weight of the motion assisting device A (or the weight obtained by subtracting the total weight of the foot attachment portions 2 and 2 from the entire weight) is set as the total lifting force standard desired value. In this case, the standard desired value of the lifting force from the seating portion 1 to the user P may also be a predetermined value (fixed value) independent of the body weight of the user P. If a vertical inertial force generated by a motion of the motion assisting device A is relatively large in comparison with the above gravity, the magnitude of the total sum of the inertial force and the gravity may be set as the total lifting force standard desired value. Although it is necessary to sequentially estimate the inertial force in this case, the estimation is able to be performed by a known method such as, for example, a method suggested by the applicant of the present invention in Japanese Patent Application Laid-Open No. 2007-330299.

Next in step S1005, a limiting process is performed for the provisional desired value of the total lifting force found as described above to determine the final desired value of the total lifting force. The limiting process is performed to prevent the desired value of the total lifting force from being excessive. In the limiting process, the provisional desired value of the total lifting force is directly determined as the desired value of the total lifting force if the provisional desired value is equal to or less than a predetermined upper limit.

On the other hand, if the provisional desired value of the total lifting force exceeds the predetermined upper limit, the upper limit is determined as the desired value of the total lifting force. In this case, the predetermined upper limit is set to, for example, the same value as the total lifting force standard desired value or to a value slightly greater than the value. Therefore, the desired value of the total lifting force is adjusted according to the battery FB correction amount while being limited so as not to be excessive relative to the total lifting force standard desired value.

In this embodiment, if the provisional desired value of the total lifting force exceeds the predetermined upper limit in the process of the step S1005, the left/right desired share determining means 63 stops the update of the integral term in the arithmetic processing of the feedback control law in the step S1003. This prevents the integral term from being excessive to the positive side in a situation where the actual average power consumption is less than the desired average power consumption. Consequently, in the case where the actual average power consumption is greater than the desired average power consumption afterward, the battery FB correction amount is able to be immediately changed to a negative-side value (a value in a direction of decreasing the desired value of the total lifting force).

The above is the details of the process of the step S100 in FIG. 7. This process causes the desired value of the total lifting force to be appropriately corrected from the total lifting force standard desired value so that the actual average power consumption gets close to the desired average power consumption while being limited not to exceed the predetermined upper limit. In this case, if the actual average power consumption at the current time is equal to or less than the desired average power consumption, the desired value of the total lifting force is basically determined so as to be equal to or less than the predetermined upper limit and substantially equal in magnitude to the total lifting force standard desired value.

On the other hand, if the actual average power consumption at the current time is greater than the desired average power consumption, the desired value of the total lifting force is determined so as to be a desired value smaller than the total lifting force standard desired value.

Here, the actual average power consumption at the current time greater than the desired average power consumption means that the SOC of the battery 19 reaches the lower limit SOCmin before the desired operating time elapses from the start of the operation of the motion assisting device A if it is assumed that the current energy consumption pattern of the battery 19 continues as it is (in other words, if it is assumed that the average power consumption representing a change pattern over time of the remaining energy amount of the battery 19 after the current time coincides with the actual average power consumption at the current time).

For example, in the example shown in FIG. 9, if the current energy consumption pattern of the battery 19 continues as it is, the accumulated discharge amount of the battery 19 increases as shown by the graph indicated by the two-dot chain line. Then, the accumulated discharge amount reaches the upper limit discharge amount corresponding to the lower limit SOCmin of the SOC before the end time point of the desired operating time. If this occurs, the battery 19 is not able to supply each electric motor 15 with power which enables the electric motor 15 to operate properly. Therefore, in the process of the step S100, the desired value of the total lifting force is decreased in the case where the actual average power consumption at the current time is greater than the desired average power consumption. This reduces the power consumption (supply power to the electric motors 15 and 15) of the battery 19 required for achieving the desired value.

Returning to the description of FIG. 7, subsequently a left/right distribution ratio calculation process is performed in step S101. The process of the step S101 may also be performed in parallel with or before the process of the step S100. The left/right distribution ratio calculation process of the step S101 is to determine a right distribution ratio, which is a ratio of a right leg link share desired value relative to the desired value of the total lifting force (approximately equal to the assisting device share supporting force), and a left distribution ratio, which is a ratio of a left leg link share desired value relative to the desired value of the total lifting force. The total sum of the right distribution ratio and the left distribution ratio is “1.”

The above left/right distribution ratio calculation process is performed as shown by the flowchart of FIG. 10. First, in step S1011, the total sum Fft_all (=Fft_R+Fft_L) is calculated from a right leg treading force measured value Fft_R and a left leg treading force measured value Fft_L, which have been found by the treading force measuring means 60R and 60L, respectively.

Subsequently, in step S1012, a value Fft_R/Fft_all obtained by dividing the right leg treading force measured value Fft_R by the total sum Fft_all is set as a provisional value of the right distribution ratio.

Subsequently, in step S1013, the right distribution ratio (the right distribution ratio at the current control processing cycle) is finally determined by applying the low-pass characteristic filtering to the provisional value of the right distribution ratio. Further, in step S1014, the left distribution ratio is determined by subtracting the right distribution ratio determined as described above from “1.” The filtering process in the step S1013 is performed to reduce a rapid change in the right distribution ratio (and then a rapid change in the left distribution ratio).

Additionally, it is also possible to determine the provisional value of the left distribution ratio, instead of determining the provisional value of the right distribution ratio in the step S1012, and then to apply the low-pass characteristic filtering to the provisional value to determine the value as a left distribution ratio. Thereafter, the right distribution ratio may be determined by subtracting the left distribution ratio determined in this manner from “1.” In this case, in the step S1012, a value Fft_L/Fft_all obtained by dividing the left leg treading force measured value Fft_L by the total sum Fft_all is determined as a provisional value of the left distribution ratio.

Returning to the description of FIG. 7, after the right distribution ratio and the left distribution ratio are determined as described above, the left/right desired share determining means 63 performs the processes of steps S102 and S107. The processes of the steps S102 and S107 may also be performed in parallel with the process of the step S100 or S101 or before the process of the step S100 or S101.

The process of the step S102 is performed to find a supporting force to be additionally applied to the right leg link 3R so that the bending degree of the right leg link 3R is restored to (brought close to) a predetermined bending degree. Similarly, the process of the step S107 is performed to find a supporting force to be additionally applied to the left leg link 3L so that the bending degree of the left leg link 3L is restored to (brought close to) a predetermined bending degree. Hereinafter, these supporting forces will be referred to as restoration supporting forces.

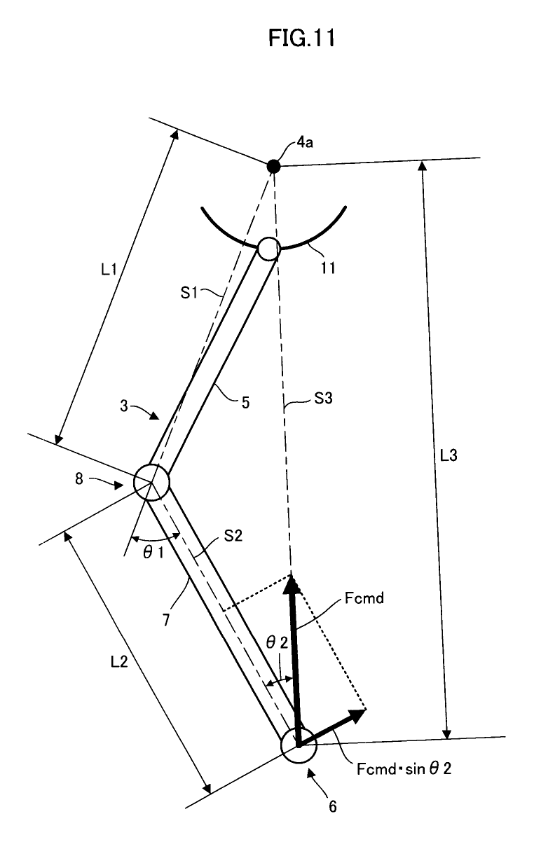

The algorithm is the same in either of the process of the step S102 and the process of the step S107. Therefore, the process of the step S102 related to the right leg link 3R is typically described hereinafter with reference to FIG. 11. FIG. 11 illustrates a modeled construction of an essential part of the leg link 3.

As shown, it is assumed that S1 is a line segment between the curvature center 4a of the guide rail 11 and the third joint 8, S2 is a line segment between the third joint 8 and the second joint 6, and S3 is a line segment between the curvature center 4a of the guide rail 11 and the second joint 6. Moreover, it is assumed that L1, L2, and L3 are the lengths of the line segments S1, S2, and S3, respectively. Further, θ2 is assumed to be an angle made by the line segment S2 and the line segment S3. Regarding a triangle having three sides of the line segments S1, S2, and S3 under the above condition, the following relational expressions (4a) and (4b) are satisfied:

L3²=L1²+L2²−2·L1·L2·cos(180°−θ1) (4a)

L1²=L2+L3²−2·L2·L3·cos θ2 (4b)

In the process of the step S102, first, the length L3 of the line segment S3 is calculated on the basis of the expression (4a) by using the measured value θ1_R of the knee angle of the leg link 3R obtained by the right knee angle measuring means 61R. In this case, the length L1 of the line segment S1 required for this calculation and the length L2 of the line segment S2 are constant values and previously stored in a memory which is not shown.

Further, the restoration supporting force is calculated by multiplying a deviation (LS3−L2) between the calculated length L3 and a predetermined reference value LS3 (a desired value of L3) by a predetermined gain k (>0) corresponding to a spring constant. In other words, the restoration supporting force is calculated by the following equation (5):

Restoration supporting force=k·(LS3−L3) (5)

The same applies to the process of the step S107 related to the left leg link 3L. The restoration supporting force of each leg link 3 determined in this manner is additionally applied to the leg link 3 so that the bending degree of the leg link 3 is restored to (brought close to) a predetermined bending degree achieved when the length L3 of the line segment S3 (namely, a distance between the curvature center 4a and the second joint 6) agrees with the predetermined reference value LS3.

In this embodiment, the restoration supporting force is determined according to the deviation between the reference value LS3 and the length L3. Alternatively, it is possible to determine the restoration supporting force according to a deviation between the knee angle measured value θ1 and the value of the knee angle θ1 corresponding to the reference value LS3 or to determine the restoration supporting force according to a deviation between a distance between the line segment S3 and the third joint 8 (=L2·sin θ2) and the reference value to the distance.

Although the expression (4b) is unnecessary in the processes of the steps S102 and S107, the expression (4b) is used for processes described later.

After performing the processes of the steps S102 and S107 as described above, the left/right desired share determining means 63 subsequently performs the processes of steps S103 to S106 related to the right leg link 3R and the processes of steps S108 to S111 related to the left leg link 3L. In the processes of the steps S103 to S106 related to the right leg link 3R, first, in the step S103, the desired value of the total lifting force determined in the step S100 is multiplied by the right distribution ratio determined in the step S101. This determines a basic value of the leg link share desired value of the right leg link 3R.

Further, in the step S104, the restoration supporting force determined in the step S102 is multiplied by the right distribution ratio. Then, the value of the multiplication result is added to the basic value of the leg link share desired value of the right leg link 3R in the step S105. This finds a provisional value of the leg link share desired value of the right leg link 3R. Further, low-pass characteristic filtering is applied to the provisional value in the step S106, by which the leg link share desired value Fcmd R of the right leg link 3R is finally determined. The filtering in the step S106 is performed to remove noise components accompanying a change or the like in the knee angle of the leg link 3R.

Similarly, in the processes of the steps S108 to S111 related to the left leg link 3L, first, in the step S108, the desired value of the total lifting force determined in the step S100 is multiplied by the left distribution ratio determined in the step S101. This determines a basic value of the leg link share desired value of the left leg link 3L. Further, in the step S109, the restoration supporting force determined in the step S107 is multiplied by the left distribution ratio. Then, the value of the multiplication result is added to the basic value of the leg link share desired value of the left leg link 3L in the step S110. This finds a provisional value of the leg link share desired value of the left leg link 3L. Thereafter, low-pass characteristic filtering is applied to the provisional value in the step S111, by which the leg link share desired value Fcmd_L of the left leg link 3L is finally determined. The filtering in the step S106 is performed to remove noise components accompanying a change or the like in the knee angle of the leg link 3L.

The above is the processing of the left/right desired share determining means 63. This processing determines the right leg link share desired value Fcmd_R and the left leg link share desired value Fcmd_L so that the ratio (proportion) between these desired values is equivalent to a proportion between the right distribution ratio and the left distribution ratio (proportion between Fft_R and Fft_L) determined according to the right leg treading force measured value Fft_R and the left leg treading force measured value Fft_L of the user. In addition, a restoration supporting force is added to the right leg link share desired value Fcmd_R and the left leg link share desired value Fcmd_L so that the bending degree of each leg link 3 does not deviate from the predetermined bending degree.

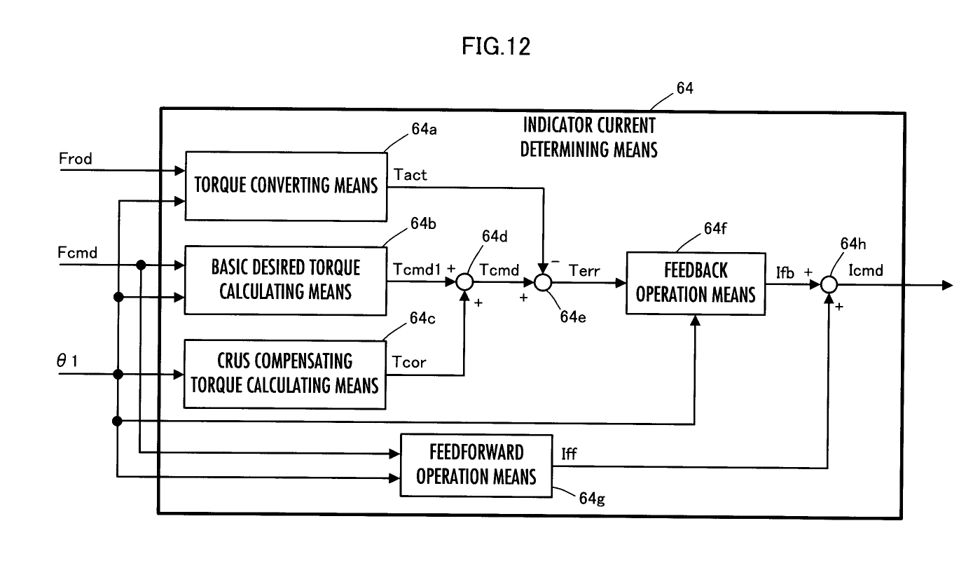

After the execution of the processing of the left/right desired share determining means 63 described above, the arithmetic processing unit 51 performs the processing of the indicator current determining means 64R and 64L. The algorithm of the processing is the same as in either of the indicator current determining means 64R and 64L. Therefore, the processing of the right indicator current determining means 64R is typically described below with reference to FIGS. 11 and 12. FIG. 12 is a block diagram illustrating a functional means of the right indicator current determining means 64R. In the description of the right indicator current determining means 64R, the reference “R” or “L” at the end of each reference numeral is omitted. Unless otherwise specified, each reference numeral is assumed to be related to the right leg link 3R (the reference “R” is assumed to be omitted).

The right indicator current determining means 64 includes a torque converting means 64a which converts a rod transmitting force measured value Frod of the connecting rod 18 measured by the right rod transmitting force measuring means 62 to a driving torque value Tact actually applied to the third joint 8 (hereinafter, referred to as the actual joint torque Tact) so as to correspond to the measured value Frod, a basic desired torque calculating means 64b which calculates a basic desired torque Tcmd1 which is a basic value of a desired value of a driving torque to be applied to the third joint 8 so as to correspond to the right leg link share desired value Fcmd determined by the left/right desired share determining means 63, and a crus compensating torque calculating means 64c which calculates a torque Tcor to be additionally applied to the third joint 8 in order to compensate an effect such as a frictional force which is caused by a rotational motion of the crus frame 7 relative to the thigh frame 5 when the third joint 8 is driven (hereinafter, referred to as the crus compensating torque Tcor).

Further, the right indicator current determining means 64 includes an addition operation means 64d which adds the crus compensating torque Tcor calculated by the crus compensating torque calculating means 64c to the basic desired torque Tcmd1 calculated by the basic desired torque calculating means 64b to determine a desired joint torque Tcmd as a final (in the current control processing cycle) desired value of the driving torque to be applied to the third joint 8 from the electric actuator 9 through the power transmission system 10, a subtraction operation means 64e which calculates a deviation Terr (=Tcmd−Tact) between the desired joint torque Tcmd and an actual joint torque Tact obtained by the torque converting means 64a, a feedback operation means 64f which calculates a feedback control input Ifb of an indicator current value of the electric motor 15 required to force the deviation Terr to “0” (to make Tact consistent with Tcmd), a feedforward operation means 64g which calculates a feedforward control input Iff of an indicator current value of the electric motor 15 required to make an actual total lifting force share of the right leg link 3 consistent with the leg link share desired value, and an addition operation means 64h which adds up the feedback control input Ifb and the feedforward control input Iff to finally determine the indicator current value Icmd.

The right indicator current determining means 64, first, performs the processing of the torque converting means 64a, the basic desired torque calculating means 64b, and the crus compensating torque calculating means 64c as described below.

The torque converting means 64a receives inputs of a rod transmitting force measured value Frod of the connecting rod 18 of the right power transmission system 10 and a knee angle measured value θ1 of the right leg link 3.

If r is a distance between the joint axis of the third joint 8 and the pivotally mounted portion 18b of the connecting rod 18 in the direction perpendicular to the lengthwise direction of the connecting rod 18 (=the direction of the rod transmitting force), a value obtained by multiplying the rod transmitting force measured value Frod by the distance r (hereinafter, referred to as the effective radius length r) is the actual joint torque Tact. Then, the effective radius length r is determined according to the knee angle of the right leg link 3. Therefore, the torque converting means 64a obtains the effective radius length r from the input knee angle measured value θ1 by using a preset arithmetic expression or data table (an arithmetic expression or data table representing the relationship between the knee angle and the effective radius length). Then, the torque converting means 64a obtains the actual joint torque Tact applied to the third joint 8 by the rod transmitting force of the measured value Frod by multiplying the input rod transmitting force measured value Frod by the obtained effective radius length r.

The processing of the torque converting means 64a is, in other words, arithmetic processing of calculating a vector product (outer product) of a rod transmitting force vector and a position vector of the pivotally mounted portion 18b of the connecting rod 18 relative to the joint axis of the third joint 8.

The basic desired torque calculating means 64b receives inputs of a right leg link share desired value Fcmd determined by the left/right desired share determining means 63 and a knee angle measured value θ1 of the right leg link 3. Then, the basic desired torque calculating means 64b calculates the basic desired torque Tcmd1 from these input values as described below. This processing will be described hereinafter with reference to FIG. 11.

Referring to FIG. 11, the supporting force applied to the leg link 3 from the floor side through the second joint 6 is able to be considered as a translational force transmitted from the second joint 6 to the curvature center 4a of the guide rail 11. In this case, the desired value of the magnitude of the translational force is the leg link share desired value Fcmd. Assuming that the translational force (supporting force) of the magnitude of the leg link share desired value Fcmd is applied from the floor side to the leg link 3, a torque balanced with a moment generated around the joint axis of the third joint 8 by the translational force vector is the basic desired torque Tcmd1 to be obtained.

Here, as understood with reference to FIG. 11, the following equation (6) is satisfied between the leg link share desired value Fcmd and the basic desired torque Tcmd1:

Tcmd1=(Fcmd·sin θ2)·L2 (6)

The right-hand side of the equation (6) represents the magnitude of a moment generated around the joint axis of the third joint 8 by the translational force vector assuming that the translational force (supporting force) of the magnitude of the leg link share desired value Fcmd is applied to the leg link 3.

Therefore, the basic desired torque calculating means 64b calculates the basic desired torque Tcmd1 by the equation (6). In this case, the L2 value required for the operation of the right-hand side of the equation (6) is previously stored in the memory which is not shown as described above. The angle θ2 is calculated on the basis of the equations (4a) and (4b) from the length L1 of the line segment S1, the length L2 of the line segment S2, and the input knee angle measured value θ1 of the right leg link 3. Similarly, the length L1 of the line segment S1 is previously stored in the memory which is not shown.

More specifically, the length L3 is able to be calculated by the equation (4b) from the L1 and L2 values and the knee angle measured value θ1. Further, the angle θ2 is able to be calculated by the equation (4a) from the calculated L3 value and the L1 and L2 values.

The above is the processing of the basic desired torque calculating means 64b.

The crus compensating torque calculating means 64c receives an input of the knee angle measured value θ1 of the right leg link 3. Then, the crus compensating torque calculating means 64c calculates a crus compensating torque Tcor by calculating the following model equation (7) using the input measured value θ1.

Tcor=A1·θ1+A2·sgn(ω1)+A3·ω1+A4·β1+A5·sin(θ1/2) (7)

where ω1 in the right-hand side of the equation (7) is a knee angular velocity as a time rate of change (derivative) of the knee angle of the right leg link 3, β1 is a knee angular acceleration as a time rate of change (derivative) of the knee angular velocity ω1, and sgn( ) is a sign function. In addition, A1, A2, A3, A4, and A5 are coefficients of predetermined values.

The first term of the right-hand side of the equation (7) is intended for decreasing the desired joint torque Tcmd in the stretching direction of the leg link 3 from the basic desired torque Tcmd1 by the magnitude of the torque applied to the third joint 8 by means of a spring (not shown) biasing the right leg link 3 in the stretching direction.

Moreover, the second term of the right-hand side represents a torque to be applied to the third joint 8 in order to drive the third joint 8 against a resistance force which is generated in the third joint 8 due to a frictional force (dynamic frictional force) between the thigh frame 5 and the crus frame 7 in the third joint 8 of the right leg link 3.

Moreover, the third term of the right-hand side represents a torque to be applied to the third joint 8 in order to drive the third joint 8 against a viscous resistance between the thigh frame 5 and the crus frame 7 in the third joint 8 of the right leg link 3, that is, a viscous resistance force according to the knee angular velocity ω1.

Further, the fourth term of the right-hand side represents a torque to be applied to the third joint 8 in order to drive the third joint 8 against an inertial force moment generated according to the knee angular acceleration β1, more specifically, a resistance force moment generated in the third joint 8 due to an inertial force produced by a motion of a part on the foot attachment portion 2 side from the third joint 8 of the right leg link 3 (a part composed of the crus frame 7, the second joint 6, and the foot attachment portion 2).

Still further, the fifth term of the right-hand side represents a torque to be applied to the third joint 8 in order to drive the third joint 8 against a resistance force moment generated in the third joint 8 due to a gravity acting on the part on the foot attachment portion 2 side from the third joint 8 of the right leg link 3 (the part composed of the crus frame 7, the second joint 6, and the foot attachment portion 2).

The angle to which the sine function sin( ) in the fifth term is to be applied is originally an angle made by the line segment S2 (the line segment between the third joint 8 and the second joint 6) in FIG. 1 and the vertical direction (gravity direction). In this embodiment, the length of the thigh frame 5 almost equals the length of the crus frame 7 and therefore the angle made by the line segment S2 and the vertical direction is approximately one half of the knee angle of the leg link 3 measured by the knee angle measuring means 61. Therefore, in this embodiment, the angle to which the sine function sin( ) in the fifth term is applied is denoted by “θ1/2.” Note that, however, in the case where an acceleration sensor or a tiltmeter is mounted on the motion assisting device A to enable the detection of an angle of inclination of the crus frame 7 (an angle of inclination of the line segment S2) relative to the gravity direction, it is preferable to use the angle of inclination, instead of “θ1/2” in the fifth term.

In order to calculate the right-hand side of the aforementioned equation (7), the crus compensating torque calculating means 64c sequentially calculates a value of the knee angular velocity ω1 required for the calculation of the right-hand side and a value of the knee angular acceleration 131 from the time series of the knee angle measured value θ1 of the right leg link 3 sequentially input from the right knee angle measuring means 61. Thereafter, the crus compensating torque calculating means 64c calculates the crus compensating torque Tcor by calculating the right-hand side of the equation (7) by using the input knee angle measured value θ1 (the current value) of the right leg link 3 and the calculated value (the current value) of the knee angular velocity ω1 and value (the current value) of the knee angular acceleration βl. The “current value” means a value obtained in the current control processing cycle of the arithmetic processing unit 51.

More specifically, the coefficients A1, A2, A3, A4, and A5 used for the operation of the equation (7) are previously identified on an experimental basis by an identification algorithm which minimizes a square value of a difference between the left-hand side value (actual measurement) and the right-hand side value (calculated value) of the equation (7) and stored in the memory which is not shown.

The above is the processing of the crus compensating torque calculating means 64c. The crus compensating torque Tcor calculated by the crus compensating torque calculating means 64c in this manner has a meaning of an additional correction amount for correcting the basic desired torque Tcmd1.

More specifically, the model equation (7) is premised on a device having a spring biasing the leg link 3 in the stretching direction. If the spring is not provided, however, the first term of the right-hand side of the equation (7) is unnecessary. Moreover, the second term among the terms of the right-hand side of the equation (7) generally represents a relatively small value in comparison with other terms and therefore may be omitted. Further, it is also possible to determine the crus compensating torque Tcor by using a model equation not including a term representing a relatively smaller value than other terms among the third, fourth, and fifth terms of the right-hand side of the equation (7). For example, if the part on the foot attachment portion 2 side from the third joint 8 of the right leg link 3 is sufficiently lightweight, one or both of the fourth and fifth terms may be omitted.

After performing the processing of the torque converting means 64a, the basic desired torque calculating means 64b, and the crus compensating torque calculating means 64c as described above, the right indicator current determining means 64 performs the processing of the addition operation means 64d. This processing includes addition of the basic desired torque Tcmd1 and the crus compensating torque Tcor obtained by the basic desired torque calculating means 64b and the crus compensating torque calculating means 64c, respectively. In other words, the basic desired torque Tcmd1 is corrected by the crus compensating torque Tcor. Thereby, the desired joint torque Tcmd (=Tcmd1+Tcor) is calculated.

The desired joint torque Tcmd calculated as described above corresponds to the controlled variable desired value according to the present invention. The desired joint torque Tcmd is, in other words, a desired value of the driving torque of the third joint 8 required for causing a desired lifting force to act on the user P from the seating portion 1.

The right indicator current determining means 64 further performs the processing of the subtraction operation means 64e. In this processing, a deviation Terr (=Tcmd−Tact) between Tcmd and Tact is calculated by subtracting the actual joint torque Tact obtained by the torque converting means 64a from the desired joint torque Tcmd obtained by the addition operation means 64d.

Subsequently, the right indicator current determining means 64 performs the processing of the feedback operation means 64f. In this processing, the deviation Terr is input to the feedback operation means 64f. Thereupon, the feedback operation means 64f calculates a feedback control input Ifb as a feedback component of the indicator current value Icmd from the input deviation Terr according to a predetermined feedback control law. As the feedback control law, for example, a PD law (proportional-derivation law) is used. In this case, the feedback control input Ifb is calculated by adding a product of the deviation Terr and a predetermined gain Kp (proportional term) to a derivative of a product of the deviation Terr and a predetermined gain Kd (derivative term).

In this embodiment, the sensitivity in the change of the lifting force of the seating portion 1 to the change of current of the electric motor (the change of the output torque) varies according to the knee angle of the leg link 3. Therefore, in this embodiment, the knee angle measured value 91 of the right leg link 3 is input to the feedback operation means 64f in addition to the deviation Terr. Moreover, the feedback operation means 64f variably sets the values of the gains Kp and Kd of the proportional term and the derivative term according to the knee angle measured value θ1 of the right leg link 3 by using a predetermined data table (a data table representing a relationship between the knee angles and the gains Kp and Kd), which is not shown.

On the other hand, the right indicator current determining means 64 performs the processing of the feedforward operation means 64g in parallel with the processing of the feedback operation means 64f. In this case, the right leg link share desired value Fcmd determined by the left/right desired share determining means 63 and the knee angle measured value θ1 of the right leg link 3 are input to the feedforward operation means 64g.

Then, the feedforward operation means 64g calculates a feedforward control input Iff as a feedforward component of the indicator current value of the electric motor 15 by using a model equation expressed by the following equation (8):

Iff=B1−Tcmd1+B2·ω1+B3·sgn(ω1)+B4·β1+B5·θ1 (8)

where Tcmd1 in the right-hand side of the equation (8) is the same as the basic desired torque Tcmd1 which is obtained by the basic desired torque calculating means 64b. Moreover, ω1 and β1 are a knee angular velocity and a knee angular acceleration, respectively, as described with respect to the equation (7). In addition, B1, B2, B3, B4, and B5 are coefficients of predetermined values.

Further, the first term of the right-hand side of the equation (8) represents a basic requested value of an applied current of the electric motor 15 required for providing the third joint 8 of the right leg link 3 with a driving torque of the basic desired torque Tcmd1, in other words, a driving torque balanced with a moment generated around the joint axis of the third joint 8 assuming that the supporting force of the right leg link share desired value Fcmd is applied to the right leg link 3 from the floor side.

Still further, the second term of the right-hand side represents a component of the applied current of the electric motor 15 required for providing the third joint 8 with a driving torque against a viscous resistance between the thigh frame 5 and the crus frame 7 in the third joint 8 of the right leg link 3, that is, a viscous resistance force between the thigh frame 5 and the crus frame 7 generated according to the knee angular velocity ω1.

Moreover, the third term of the right-hand side represents a component of the applied current of the electric motor 15 required for providing the third joint 8 with a driving torque against a dynamic frictional force between the thigh frame 5 and the crus frame 7 in the third joint 8 of the right leg link 3.

Further, the fourth term of the right-hand side represents a component of the applied current of the electric motor 15 required for providing the third joint 8 with a driving torque against an inertial force moment generated according to the knee angular acceleration βl.

Still further, the fifth term of the right-hand side is intended for decreasing the applied current of the electric motor 15 for generating the driving torque in the stretching direction of the leg link 3 by a magnitude of the torque applied to the third joint 8 by the spring (not shown) biasing the right leg link 3 in the stretching direction.

In this case, the feedforward operation means 64g calculates the knee angular velocity ω1 and the knee angular acceleration β1 required for the right-hand side operation of the equation (8) from the time series of the input knee angle measured value θ1 of the right leg link 3 in the same manner as for the processing of the crus compensating torque calculating means 64c. Moreover, the feedforward operation means 64g calculates the basic desired torque Tcmd1 necessary for the right-hand side operation of the equation (8) from the input right leg link share desired value Fcmd and the knee angle measured value θ1 by the same arithmetic processing as one for the basic desired torque calculating means 64b. The feedforward operation means 64g then calculates the feedforward control input Iff by performing the right-hand side operation of the equation (8) using the input knee angle measured value θ1 of the right leg link 3 (the current value), the calculated value of the knee angular velocity θ1 (the current value), the knee angular acceleration βl (the current value), and the calculated basic desired torque Tcmd1 (the current value).

More specifically, the values of the coefficients B1, B2, B3, B4, and B5 for use in the operation of the equation (8) are previously identified on an experimental basis by an identification algorithm which minimizes a square value of a difference between the left-hand side value (actual measurement) and the right-hand side value (calculated value) of the equation (8) and stored in the memory which is not shown. The model equation (8) is premised on a device having a spring biasing the leg link 3 in the stretching direction. If the spring is not provided, however, the fifth term of the right-hand side of the equation (8) is unnecessary. Moreover, the feedforward control input Iff may be determined by a model equation in which the second or fourth term is omitted among the terms of the right-hand side of the equation (8). Further, a basic desired torque Tcmd1 calculated by the basic desired torque calculating means 64b may be input, instead of an input of the leg link share desired value Fcmd to the feedforward operation means 64g. In this case, there is no need to calculate the basic desired torque Tcmd1 by means of the feedforward operation means 64g.

After performing the processing of the feedback operation means 64f and the feedforward operation means 64g, the indicator current determining means 64 performs the processing of the addition operation means 64h. This processing includes addition of the feedback control input Ifb and the feedforward control input Iff obtained by the feedback operation means 64f and the feedforward operation means 64g, respectively. Thereby, the indicator current value Icmd of the right electric motor 15 is calculated.

The above is the details of the processing of the right indicator current determining means 64R. The processing of the left indicator current determining means 64L is similarly performed.

The arithmetic processing unit 51 outputs the indicator current value Icmd_R and Icmd_L determined by the indicator current determining means 64R and 64L as described above to the driver circuits 52R and 52L corresponding to the electric motors 15R and 15L, respectively. At this point, the driver circuits 52 apply the currents to the electric motors 15, respectively, according to the given indicator current values Icmd.

More specifically, in this embodiment, the left/right desired share determining means 63 and the indicator current determining means 64R and 64L implement the power regulation means according to the present invention.

The control processing of the arithmetic processing unit 51 described above is performed at predetermined control processing cycles. This enables a feedback control of the output torque of each electric motor 15 and consequently of the driving torque applied to the third joint 8 of each leg link 3 from each electric actuator 9 so that the actual joint torque Tact of each leg link 3 coincides with (converges on) the desired joint torque Tcmd. In other words, the motive power of the electric actuators 9R and 9L are controlled so that the actual supporting force acting on each leg link 3 from the floor side coincides with the leg link share desired value Fcmd and consequently so that the total sum of the both leg link share desired values Fcmd_R and Fcmd_L coincides with the desired value of the total lifting force. As a result, the targeted lifting force (the lifting force obtained by subtracting the supporting force which supports the weight of the motion assisting device A from the desired value of the total lifting force) acts on the user P from the seating portion 1. This reduces the load on the legs of the user P.

In this case, the desired value of the total lifting force is determined so that the actual average power consumption is brought close to the desired average power consumption while being limited so as not to exceed the predetermined upper limit, as described above. Particularly, if the actual average power consumption is greater than the desired average power consumption, in other words, if the SOC at the end point of the desired operating time is predicted to be reduced to less than the lower limit SOCmin, the desired value of the total lifting force is corrected in the decreasing direction relative to the total lifting force standard desired value in order to bring the actual average power consumption close to the desired average power consumption.

As a result, the output torques of the electric motors 15 and 15 are controlled in such a way as to prevent the SOC of the battery 19 from being less than the lower limit SOCmin before the end point of the desired operating time. Consequently, it is possible to prevent such a situation where the remaining energy of the battery 19 runs out during operation of the motion assisting device A within the desired operating time and thereby the electric actuators 9 and 9 are disabled.

Moreover, the desired value of the total lifting force is limited to a predetermined upper limit or lower (consequently, the lifting force from the seating portion 1 to the user P is limited to the predetermined upper limit or lower). Therefore, particularly if the actual average power consumption is lower than the desired average power consumption, it is possible to prevent the desired value of the total lifting force (consequently, the lifting force from the seating portion 1 to the user P) from being too excessive. Further, in this case, the update of the integral term in the arithmetic processing of the feedback control law in the step S1003 is stopped in a situation where the desired value of the total lifting force is forcibly limited to the upper limit (if the provisional desired value of the total lifting force exceeds the upper limit). Therefore, in the case where the actual average power consumption exceeds the desired average power consumption and thus the desired value of the total lifting force needs to be regulated in the decreasing direction, the desired value of the total lifting force is able to be immediately decreased.

Subsequently, some variations of this embodiment will be described below.

In the above embodiment, the SOC is used as the first index value of the battery 19 as an electrical storage device. Alternatively, for example, so-called DOD (depth of discharge) or an open-circuit voltage (a terminal-to-terminal voltage in a state where the current does not flow through the battery 19) may be used as the first index value. Moreover, if the capacitor is used as an electrical storage device, the amount of remaining charge as an indication of a remaining energy amount of the capacitor is proportional to a voltage of the capacitor. Therefore, the voltage value of the capacitor may be used as the first index value.

Moreover, the actual average power consumption of the battery 19 is used as the second index value in this embodiment. Alternatively, for example, an average amount of change per unit time of the first index value such as the SOC may be used as the second index value. Moreover, in this embodiment, the actual average power consumption as the second index value is obtained as an average value of the power consumption for the period from the current time (the time point at which the latest SOC is measured) back to a predetermined time ago. Alternatively, for example, an average value of power consumption for the period from the start of operation of the motion assisting device A (the start of work) to the current time may be obtained as the actual average power consumption (the second index value). In such a case, a change over time of the actual average power consumption is reduced. This consequently reduces a change in the desired value of the total lifting force and reduces a change in the lifting force (assisting force) applied to the user P from the seating portion 1.

Further, for example, a change pattern in time series of the SOC measured by the SOC measuring means 65 may be monitored to regulate the motive power of the electric actuator 9 according to the change pattern. For example, it is possible to preset a rule that specifies how the motive power of the electric actuator 9 should be changed in the case of occurrence of a characteristic change pattern of the SOC measured value (for example, a pattern such that the SOC measured value rapidly decreases) and then to regulate the motive power of the electric actuator 9 on the basis of the rule.

Moreover, in this embodiment, the desired value of the total lifting force is adjusted by correcting the provisional desired value of the total lifting force using the control input (battery FB correction amount) obtained by the arithmetic processing of the feedback control law in the step S1003. Alternatively, for example, a spring constant k (the gain k in the equation (5)) related to the restoration supporting force may be corrected according to the control input obtained by the arithmetic processing of the feedback control law in the step S1003. In this case, the value of the spring constant k may be modified in the decreasing direction, for example, in a situation where the control input obtained by the arithmetic processing of the feedback control law in the step S1003 is a negative value (in a situation where the actual average power consumption is greater than the desired average power consumption). This also enables the remaining energy in the battery 19 to be prevented from running out during the desired operating time.

Further, in this embodiment, the output torque of the electric motor 15 is controlled so that the actual joint torque Tact of the third joint 8 coincides with the desired joint torque Tcmd in the processing of the indicator current determining means 64. Alternatively, for example, the desired value of the rod transmitting force is determined and then the output torque of the electric motor 15 may be controlled so that the rod transmitting force measured value Frod coincides with the desired value. In this case, the desired value of the rod transmitting force is determined by performing inverse processing (processing of dividing the desired joint torque Tcmd by the effective radius length r) to the processing of the torque converting means 64a with respect to the desired joint torque Tcmd determined as described above.

Alternatively, for example, the supporting force actually acting on each leg link 3 from the floor side may be measured by using the force sensor interposed between the leg link 3 and the second joint 6 and then the motive power of the electric actuator 9 may be controlled so that the measured value coincides with the leg link share desired value Fcmd.

Further, if the frictional force or the inertial force moment in the third joint 8 is sufficiently small, the crus compensating torque calculating means 64c may be omitted. In this case, the basic desired torque Tcmd1 may be directly used as the desired joint torque Tcmd.

Moreover, the power transmission system 10 is composed of the drive crank arm 16, the driven crank arm 17, and the connecting rod 18. Alternatively, for example, the motive power of the electric actuator 9 (the rotary actuator) may be transmitted to the connecting rod 18 through a ball screw mechanism and be applied to the third joint 8 through the driven crank arm 17. Alternatively, the motive power of the electric actuator 9 may be transmitted to the third joint 8 through a wire. Further, the electric actuator 9 may be provided coaxially with the joint axis of the third joint 8, so that the motive power of the electric actuator 9 is directly applied to the third joint 8. Further, in this embodiment, the first joint 4 is adapted to have the arcuate guide rail 11, so that the curvature center 4a of the guide rail 11 as a swing fulcrum in the longitudinal direction of each leg link 3 is located above the seating portion 1. Alternatively, the first joint 4 may be formed by a simple joint structure in which the upper end portion of the leg link 3 is pivotally supported by a lateral (horizontal) shaft in the side or lower part of the seating portion 1.

Moreover, in the motion assisting device intended for assisting a user lame in one leg due to a fracture of the bone or the like in walking, it is also possible to keep only the leg link on the side of the lame leg of the user out of the left and right leg links 3 and 3 in this embodiment, with the other leg link omitted.

Further, in this embodiment, a motion assisting device has been described taking an example of the motion assisting device A which applies the upward translational force to the trunk of the user P. The motion assisting device according to the present invention is not limited thereto. For example, the present invention is also applicable to a motion assisting device which applies a moment to be an assisting force to at least one of the hip joint, the knee joint, and the ankle joint of each leg of the user P and a motion assisting device which applies an assisting force (a translational force or a moment) to an arm of the user P for assisting the motion thereof. Further, the electric actuator provided in the motion assisting device is not limited to a rotary type, but may be a linear type actuator.

What is claimed is:

1. A motion assisting device having an assisting force transmitting portion which is brought into contact with a predetermined region of a user in such a way that an assisting force for assisting the user in making motions is transmittable to the user, an electric actuator, and an electrical storage device as a power supply of the electric actuator to cause the assisting force transmitting portion to generate the assisting force by motive power of the electric actuator, the device comprising:
a first index value measuring means which measures a first index value indicating a remaining energy amount of the electrical storage device; and
a power regulation means which regulates the motive power of the electric actuator after the time point of measuring the first index value at least according to the first index value measured by the first index value measuring means.

2. The motion assisting device according to claim 1, wherein:
data which defines desired operating time from the start of operation of the motion assisting device is preset to the power regulation means; and
the power regulation means regulates the motive power of the electric actuator after the time point of measuring the first index value according to the measured first index value and the remaining operating time which is a period of time from the time point of measuring the first index value to the end time point of the desired operating time so that the remaining energy amount of the electrical storage device is maintained at a predetermined lower limit or greater during the period of time from the time point of measuring the first index value to the end time point of the desired operating time.

3. The motion assisting device according to claim 2, wherein:
the first index value measuring means sequentially measures the first index value after the start of operation of the motion assisting device; and
the power regulation means includes a second index value calculation means which calculates a second index value indicating a change pattern over time of the remaining energy amount of the electrical storage device predicted after the time point of measuring the latest first index value in the time series of the first index value on the basis of the time series of the measured first index value, and a desired second index value determining means which determines a desired second index value which is a desired value of the second index value requested in order to make the remaining energy amount of the electrical storage device at the end time point of the desired operating time coincide with the predetermined lower limit on the basis of the latest first index value and the remaining operating time from the time point of measuring the latest first index value, and at least in the case where the remaining energy amount of the electrical storage device at the end time point of the desired operating time predicted from the second index value calculated by the second index value calculation means is less than the predetermined lower limit, the motive power of the electric actuator is regulated so that the second index value calculated by the second index value calculation means is brought close to the desired second index value determined by the desired second index value determining means.

4. The motion assisting device according to claim 3, wherein the power regulation means further includes a power regulation control input determining means, which determines a control input for regulating the motive power of the electric actuator according to a feedback control law so as to bring a deviation between the determined desired second index value and the calculated second index value close to “0” according to the deviation, and regulates the motive power of the electric actuator according to the control input while limiting the motive power of the electric actuator so that the assisting force generated in the assisting force transmitting portion stays within a predetermined upper limit.

5. The motion assisting device according to claim 4, wherein the feedback control law is a feedback control law having an integral term of the deviation as a component of the control input and the power regulation means stops an update of a value of the integral term by the power regulation control input determining means in the case where the limitation on the motive power of the electric actuator causes the assisting force generated in the assisting force transmitting portion to be set to the predetermined upper limit.
